(19) United States
(12) Patent Application Publication
(10) Pub. No.: US 2024/0283266 A1
(43) Pub. Date: Aug. 22, 2024

(54) CHARGING APPARATUS WITH A RACETRACK-SHAPED BASE FOR CHARGING HEADSET AND CONTROLLERS, AND SYSTEMS AND METHODS OF USE THEREOF

(71) Applicant: Meta Platforms Technologies, LLC, Menlo Park, CA (US)

(72) Inventors: Richard Andrew Sorensen, Camas, WA (US); Anthony Torris, Mercer Island, WA (US); David Michael Pickett, Seattle, WA (US); Peter Wesley Bristol, Seattle, WA (US)

(21) Appl. No.: 18/583,791

(22) Filed: Feb. 21, 2024

Related U.S. Application Data
(60) Provisional application No. 63/486,218, filed on Feb. 21, 2023.
(60) Provisional application No. 63/583,219, filed on Sep. 15, 2023.

(51) Int. Cl. H02J 7/00

(52) U.S. Cl. CPC H02J 7/0045; H02J 7/0048

(57) ABSTRACT

An apparatus, system, and method for charging an artificial-reality headset and one or more controllers using a mechanically-stable, yet slim/lightweight design, is provided. The charging apparatus in one example includes a racetrack-shaped weighted base that includes a top surface and a bottom surface. An elongated cradle is mounted to the elongated base and is positioned entirely above the top surface of the racetrack-shaped weighted base. The elongated cradle includes metal contacts configured to engage with metal contacts of the headset and at least charge the headset. A first and a second controller dock are also mounted to the elongated base and are positioned entirely above the top surface of the racetrack-shaped weighted base. The controller docks are configured for wirelessly charging a first and a second controller.

### CROSS-REFERENCE TO RELATED APPLICATIONS

This application claims priority to U.S. Prov. App. No. 63/486,218, filed on Feb. 21, 2023, and entitled “Charging Apparatus With A Racetrack-Shaped Base For Charging Headset And Controllers, And Systems And Methods Of Use Thereof” and U.S. Prov. App. No. 63/583,219, filed on Sep. 15, 2023, and entitled “Charging Apparatus With A Racetrack-Shaped Base For Charging Headset And Controllers, And Systems And Methods Of Use Thereof,” each of which is incorporated herein by reference.

### TECHNICAL FIELD

This application generally relates to a charging apparatus for charging a headset and controllers. The described charging apparatus is more specifically for charging artificial-reality headsets, and the controllers associated with such headsets, and includes a racetrack-shaped base, which may be appropriately weighted as well, and other features to properly hold and charge these designs.

### BACKGROUND

It is desirable for a user of an artificial-reality headsets to be able to move around freely without requiring a headset or controller to be connected to power via an external power cable or charging cable during use, and as such designing artificial-reality headsets to use rechargeable batteries (or similar rechargeable power sources) is desirable. Artificial-reality headsets and controllers with batteries must be re-charged after prolonged periods of use and it is desirable for the user to be able to conveniently charge the headset and controllers together, and in a space-saving fashion. While some charging devices exist, they may suffer from drawbacks including one or more of: the need to use multiple cables to charge headsets and controllers individually, a bulky design, a design that does not properly account for a variety of accessories that might be coupled with a headset, a design that does not properly account for the weight of a headset as compared to the lighter controllers, a design that does not appropriately account for the geometry, weight, weight distribution, etc. of the components of the artificial-reality system, quick and convenient mounting and dismounting of the components of the artificial-reality system, and others.

As such, there is a need to address one or more of the above-identified drawbacks and challenges. A brief summary of solutions to one or more of the issues noted above is described below.

### SUMMARY

The apparatus, system, and method described herein allow for the charging of a headset and controllers on a charging apparatus. The charging apparatus may charge the headset and controllers individually or all at the same time. The charging apparatus comprises a racetrack-shaped weighted base that includes an elongated cradle for charging a headset. The controller charging dock(s) are positioned above the top surface of the racetrack-shaped weighted base such that an air gap is created between part of a bottom surface of the first controller dock and the top surface of the racetrack-shaped weighted base. This, in addition to other features of some embodiments of the charging apparatus, system, and method are discussed further herein.

One example of a charging apparatus comprises a racetrack-shaped weighted base, which includes a top surface and a bottom surface. The top surface and the bottom surface of the racetrack-shaped weighted base are both substantially flat. An elongated cradle is mounted to the racetrack-shaped weighted base. The elongated cradle is positioned above the top surface of the racetrack-shaped weighted base such that an air gap is created between part of a bottom surface of the elongated cradle and the top surface of the racetrack-shaped weighted base. The elongated cradle includes one or more metal contacts configured for charging a headset. The elongated cradle is also configured to align the one or more metal contacts with corresponding metal contacts on a portion of the headset that is received by the elongated cradle. The racetrack-shaped weighted base further comprises a first controller dock mounted to the racetrack-shaped weighted base. The first controller dock is positioned above the top surface of the racetrack-shaped weighted base such that an air gap is created between part of a bottom surface of the first controller dock and the top surface of the racetrack-shaped weighted base, and is configured for receiving and wirelessly charging a first controller. The racetrack-shaped weighted base further comprises a second controller dock mounted to the racetrack-shaped weighted base. The second controller dock is positioned above the top surface of the racetrack-shaped weighted base such that an air gap is created between part of a bottom portion of the second controller dock and the top surface of the racetrack-shaped weighted base and is configured for receiving and wirelessly charging a second controller. By employing a racetrack-shaped base with substantially flat surfaces, a weighted base, as well as air gaps for the controller docks (among other features), this charging apparatus is thus designed to have a slim profile, but still allow for stably holding and charging both the headset and the controllers. An example of the charging apparatus with these features (and others) is shown from various views in FIGS. 1A-1I, 5A-L-2.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings.

FIGS. 1A-1I illustrate different views of an example charging apparatus in accordance with some embodiments.

FIG. 2 shows a schematic view of the racetrack-shaped weighted base and certain features of the racetrack-shaped weighted base in accordance with some embodiments.

FIGS. 3A-3B illustrate different views of an example system of a charging apparatus on which a headset and controllers have been docked in their respective charging positions, in accordance with some embodiments.

FIG. 4 provides a method of performing steps of some embodiments of the charging apparatus.

FIGS. 5A-5L-2 illustrate different views of another example charging apparatus in accordance with some embodiments.

FIGS. 6A-6D-2 illustrate example artificial-reality systems, in accordance with some embodiments.

FIGS. 7A-7C illustrate example head-wearable devices, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, consistent with common practice, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without some of the specific details. Furthermore, well-known processes, components, and materials have not necessarily been described in exhaustive detail so as to avoid obscuring pertinent aspects of the embodiments described herein.

Embodiments of this disclosure may include or be implemented in conjunction with various types or embodiments of artificial-reality systems. Artificial-reality, as described herein, is any superimposed functionality and or sensory-detectable presentation provided by an artificial-reality system within (or rendered to appear on top of) a user's physical surroundings. Such artificial-realities may include and/or represent virtual reality (VR), augmented reality (AR), mixed artificial-reality (MAR), or some combination and/or variation one of these. For example, a user may perform a swiping in-air hand gesture to cause a song to be skipped by a song-providing API providing playback at, for example, a home speaker. In some embodiments, of an AR system, ambient light (e.g., a live feed of the surrounding environment that a user would normally see) may be passed through a display element of a respective head-wearable device presenting aspects of the AR system. In some embodiments, ambient light may be passed through respective aspect of the AR system. For example, a visual user interface element (e.g., a notification user interface element) may be presented at the head-wearable device, and an amount of ambient light (e.g., 15-50% of the ambient light) may be passed through the user interface element, such that the user may distinguish at least a portion of the physical environment over which the user interface element is being displayed.

Artificial-reality content may include completely generated content or generated content combined with captured (e.g., real-world) content. The artificial-reality content may include video, audio, haptic events, or some combination thereof, any of which may be presented in a single channel or in multiple channels (such as stereo video that produces a three-dimensional effect to a viewer). Additionally, in some embodiments, artificial reality may also be associated with applications, products, accessories, services, or some combination thereof, which are used, for example, to create content in an artificial reality and/or are otherwise used in (e.g., to perform activities in) an artificial reality.

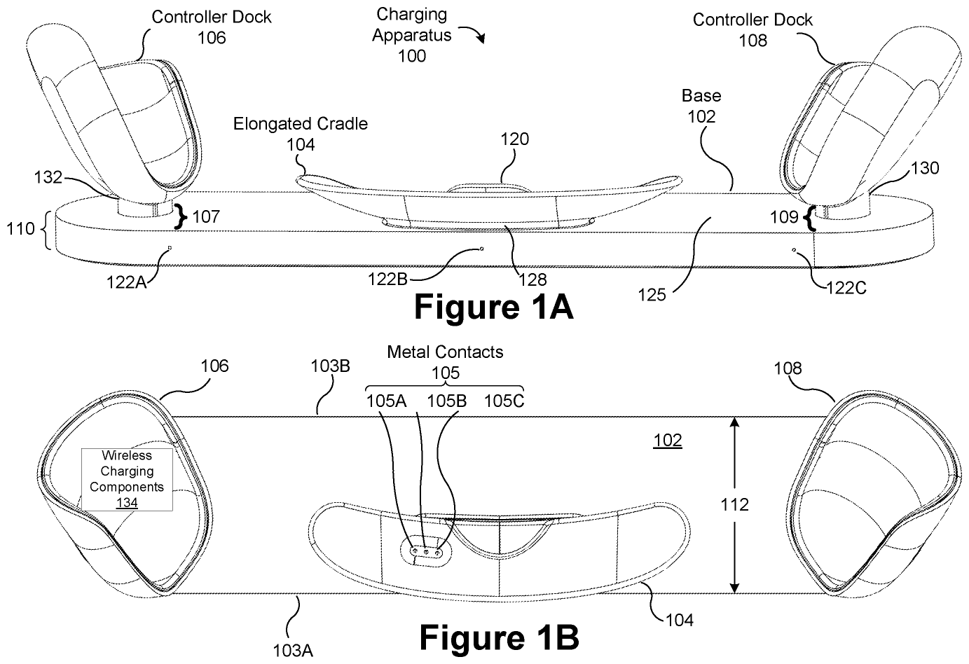

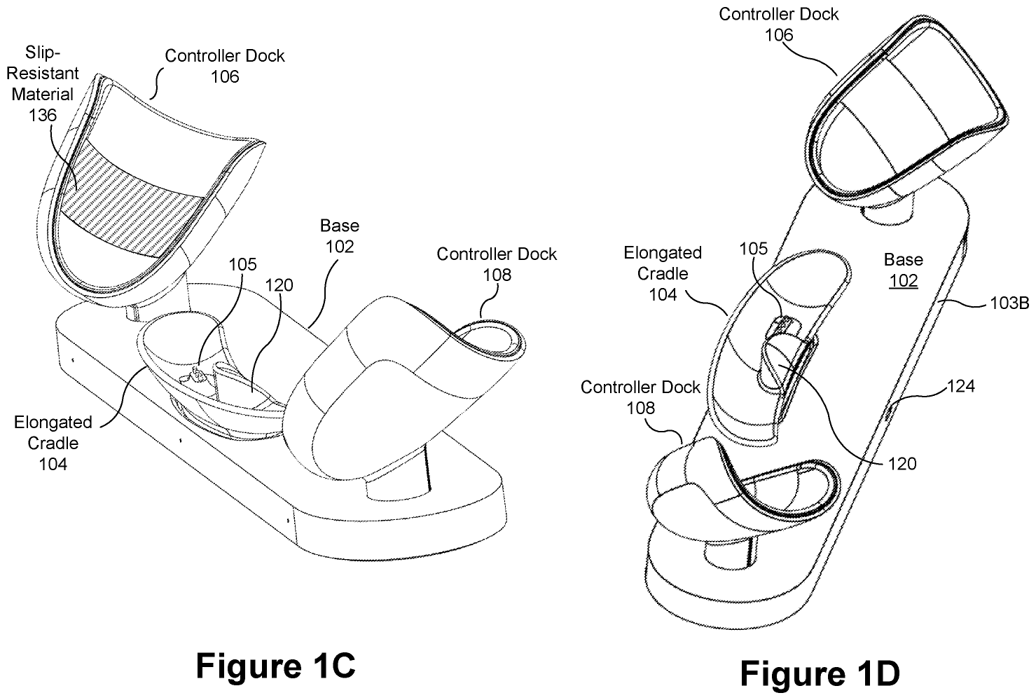

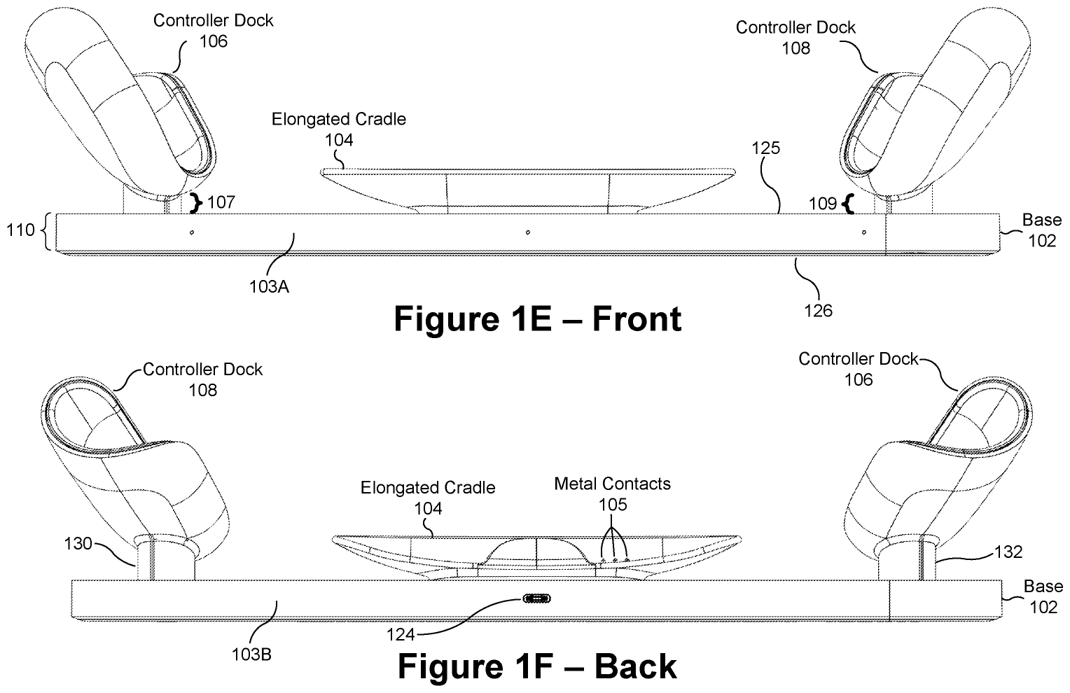

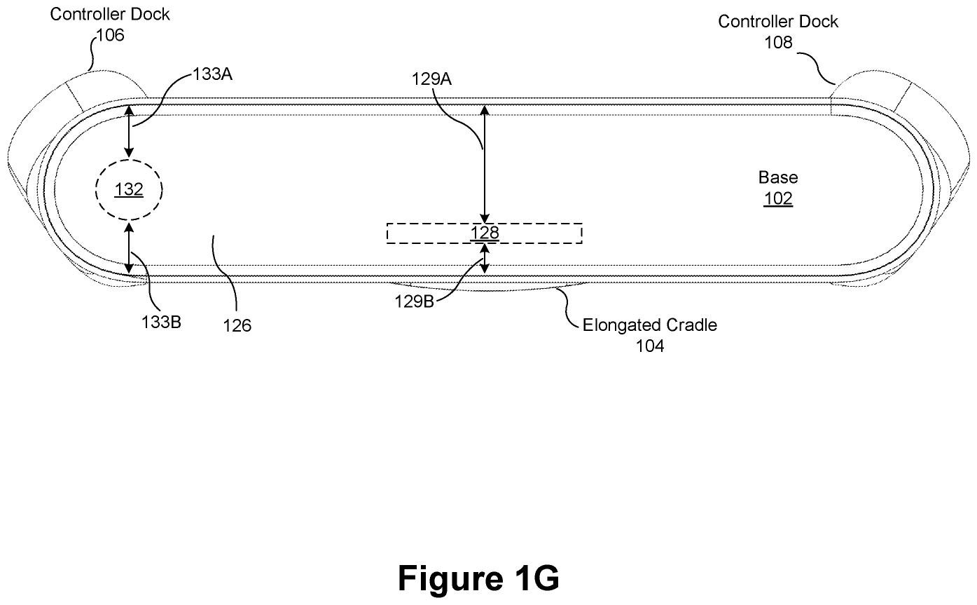

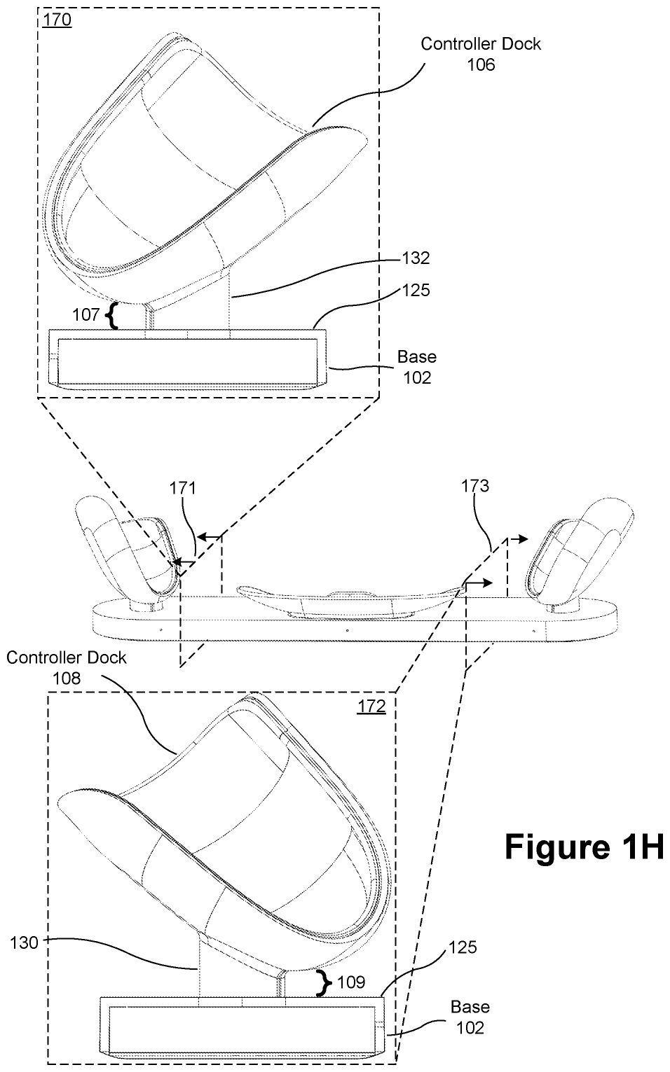

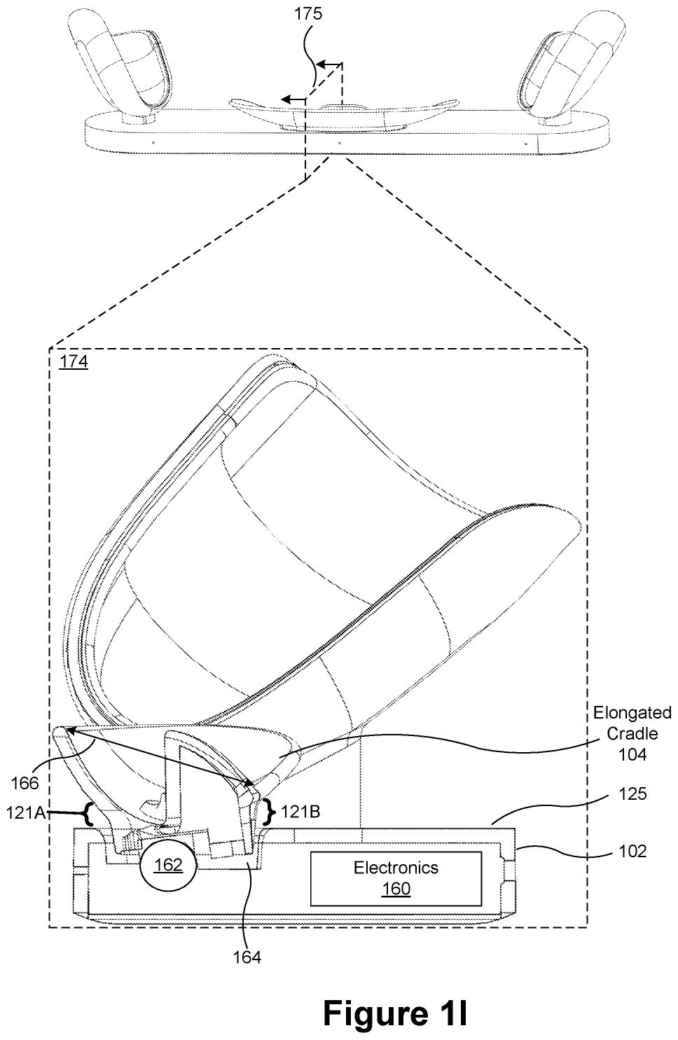

Each of the figures will now be described in turn, beginning with FIG. 1A.

FIGS. 1A-1I illustrate different views of an example charging apparatus in accordance with some embodiments. FIGS. 1A to 1I may also include references to certain example elements or features that may be included in certain locations or in certain components, or that may be excluded or at different locations in different embodiments, as a skilled artisan will understand upon reading this detailed description.

FIG. 1A shows a front view of an example embodiment of the charging apparatus 100. Charging apparatus 100 includes a base 102, an elongated cradle 104, controller dock 106 (which may be referred to as a first controller dock), and controller dock 108 (which may be referred to as a second controller dock). Base 102 has a thickness or height 110, top surface 125, and three lights 122A-122C. Elongated cradle 104 is attached to the base 102 through cradle mount 128. The cradle mount 128 may be rigid, pivotable, or otherwise adjustable, for example to better support and maintain a consistent charging connection between a head-wearable device and the elongated cradle 104.

Controller dock 106 is attached to the base 102 through post 132. Controller dock 108 is attached to base 102 through post 130. Controller docks 106 and 108 are positioned such that the bottom surface of controller dock 106 and the bottom surface of controller dock 108 are separated from, and above, the top surface 125 of base 102, such that an air gap is created between the controller docks 106, 108 and the base 102. As shown in FIG. 1A, air gap 107 separates the bottom portion of the controller dock 106 from the top surface 125 of the base 102. Air gap 109 similarly separates the bottom portion of the controller dock 108 from the top surface 125 of the base 102. In the depicted example of FIG. 1A, the air gaps 107 and 109 are of a same size, but other embodiments are also contemplated in which the air gaps 107 and 109 may be differently sized (e.g., one of the air gaps may be between 0.5-5 mm larger or smaller than the other air gap).

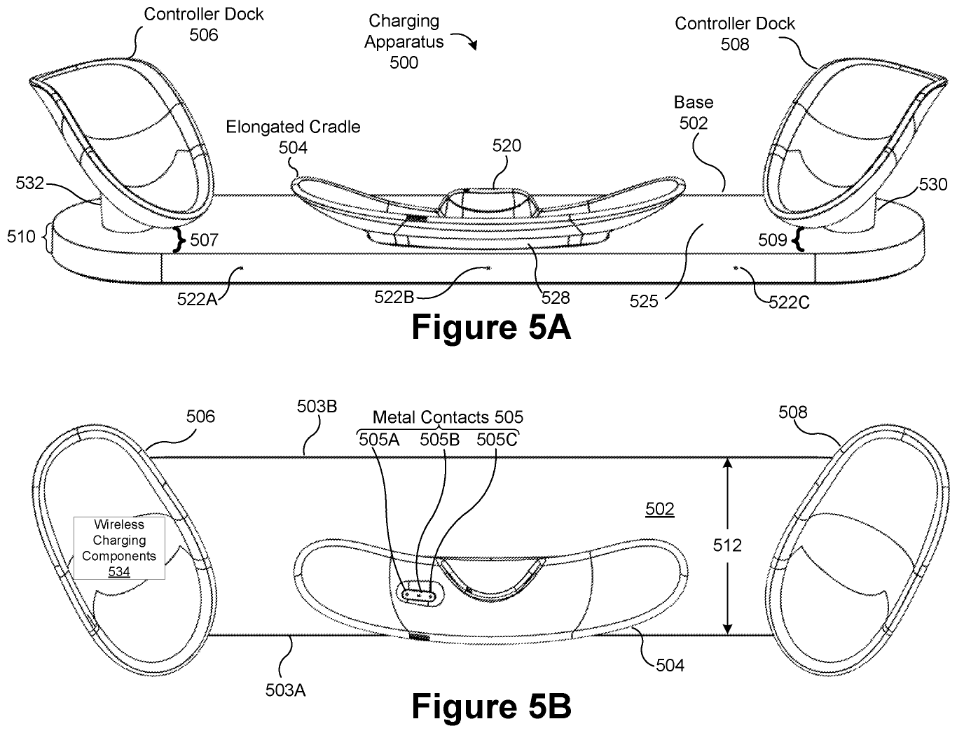

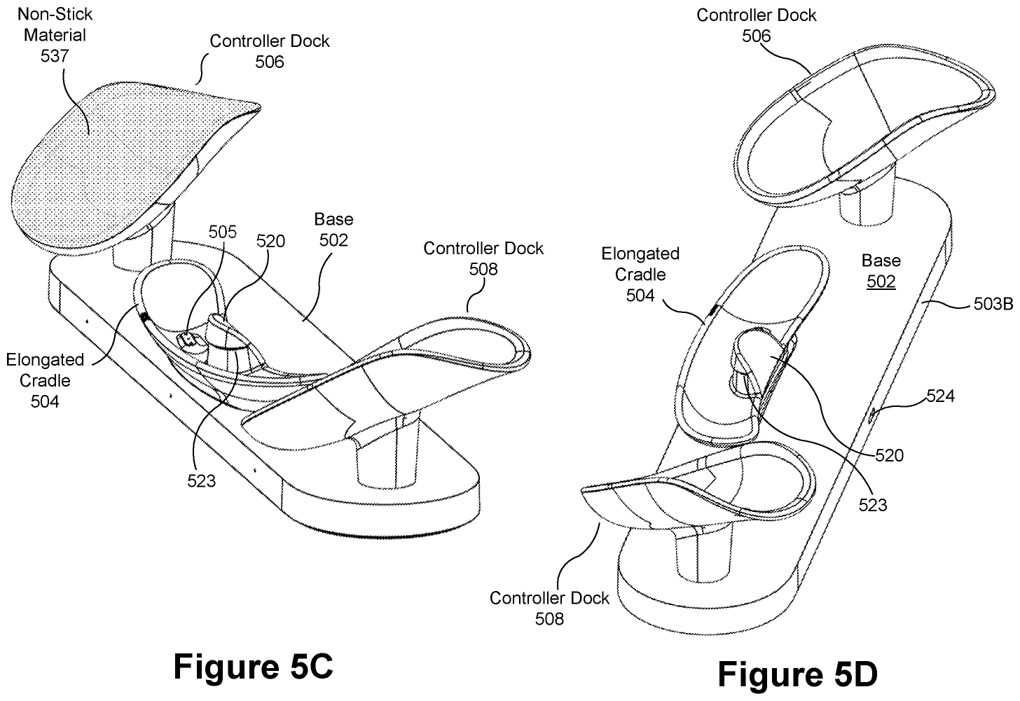

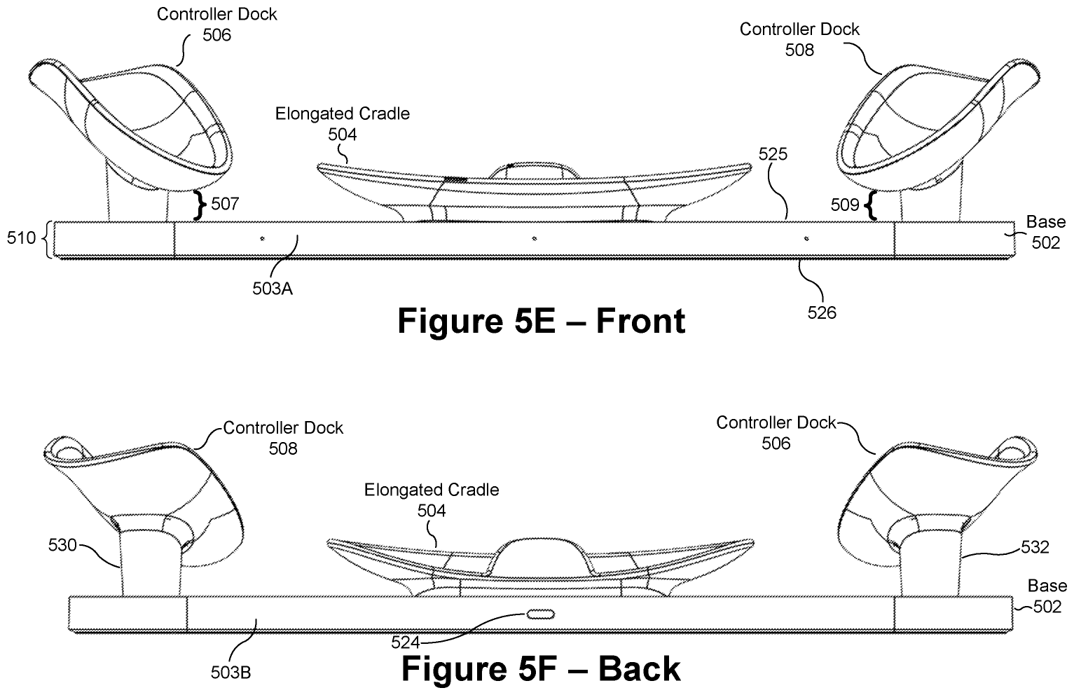

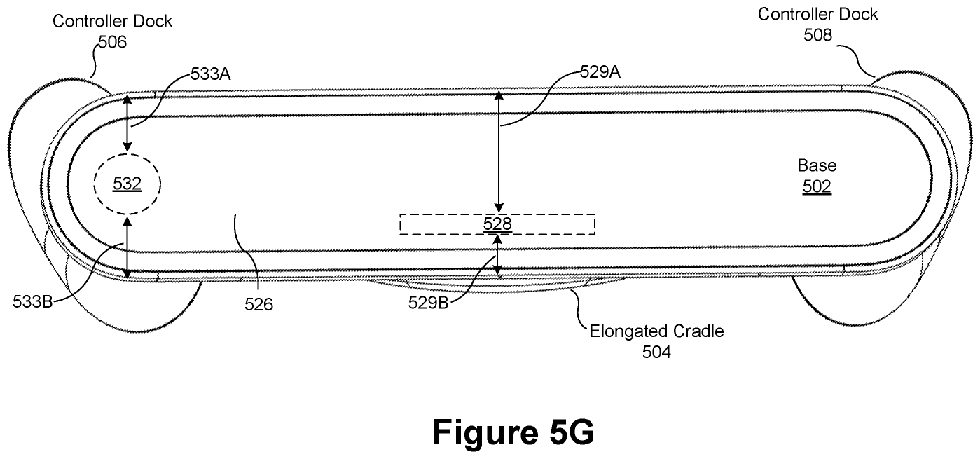

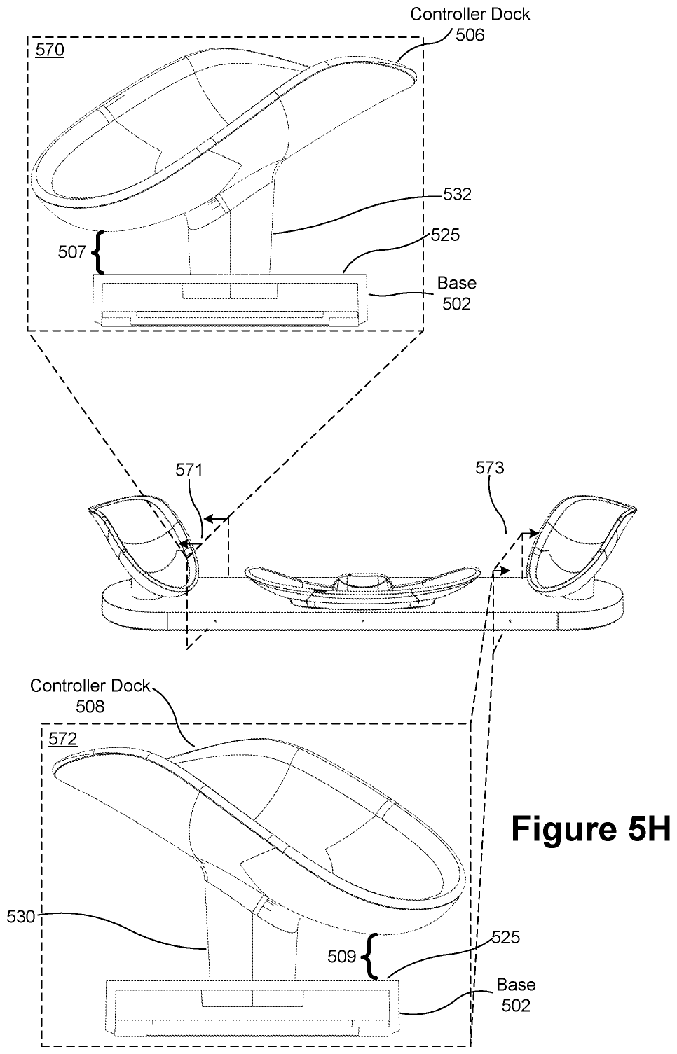

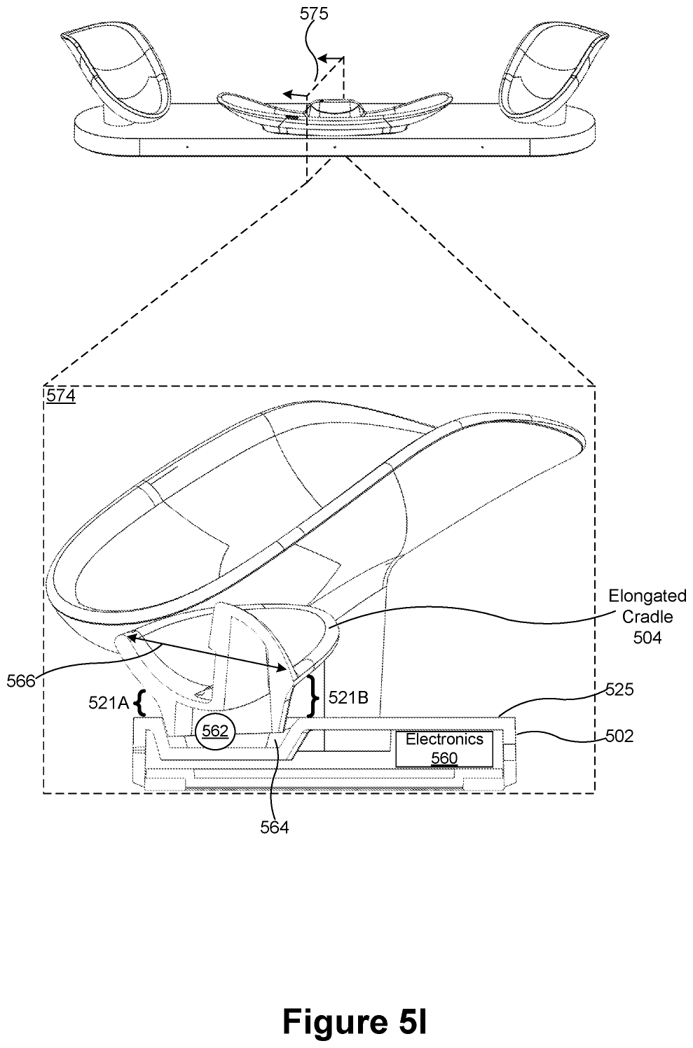

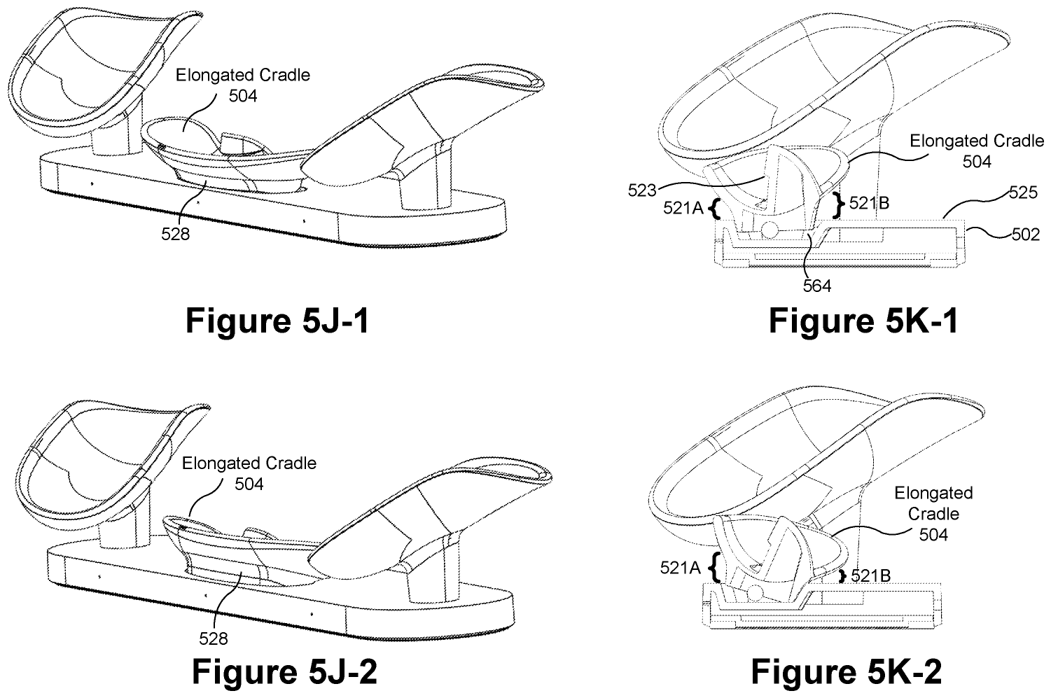

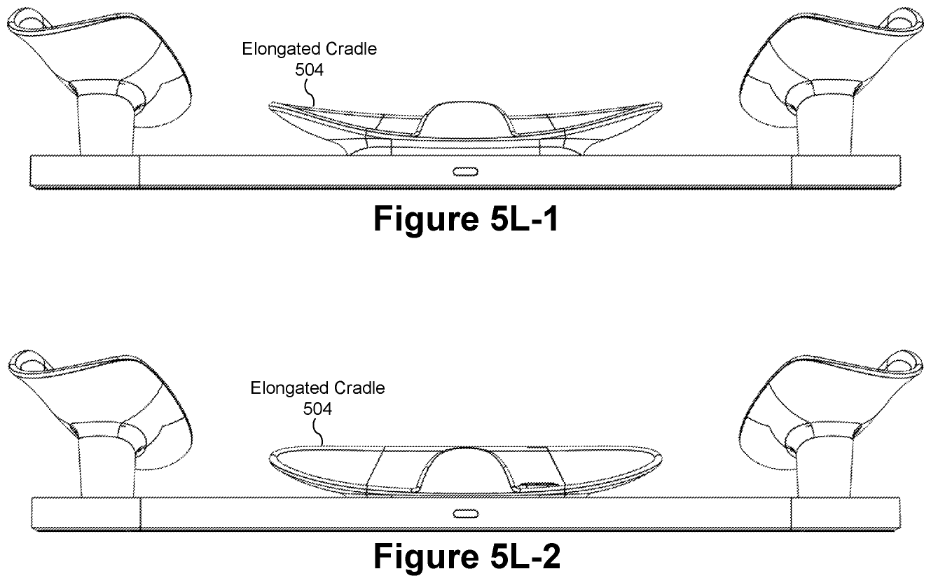

The elongated cradle 104 is configured to charge a head-wearable device, for example an artificial-reality head-wearable device. The elongated cradle may include a protrusion 120 that is configured to align with an indent (e.g., nose indent 520 in FIG. 5B) of a head-wearable device. The elongated cradle 104 is configured to receive at least a portion of a head-wearable device and charge the head-wearable device upon establishing an electrical contact with a charging portion of the head-wearable device (e.g., metal contact, which may be established via pogo pins in one example). Controller docks 106, 108 are configured to receive at least a portion of a controller and charge the respective controllers. In some embodiments, controller dock 106 is configured to receive a first controller and controller dock 108 is configured to receive a second controller. In some embodiments, a first and a second controller could be received by either controller dock 106 or 108.

The lights 122A-122C may be used to indicate charge status of the respective components being charged by the charging apparatus 100. For example, light 122A may indicate the charge status of a controller charging on controller dock 106; light 122B may indicate the charge status of a head-wearable device charging on the elongated cradle 104; and light 122C may indicate the charge status of a controller charging on controller dock 108. In other embodiments, instead of including three separate lights 122A-122C, the charging apparatus 100 may including an alphanumeric display that indicates respective charge levels for each respective device in one place (e.g., a name of each device alongside a percentage charge level of that device) or may include a circular light display divided into thirds such that each third of the circular light display provides an indication of charge status for a respective device.

FIG. 1B shows a top view of an embodiment of the charging apparatus 100. Base 102 includes two substantially parallel (e.g., within +/−5 degrees of parallel) edges—front edge 103A and back edge 103B. The depth 112 of the base 102, defined as the distance between the parallel edges 103A and 103B, is also shown in FIG. 1B. The elongated cradle 104 further includes metal contacts 105, which may include three separate metal contacts 105A-105C. As discussed elsewhere in this specification, the metal contacts 105 may be pogo-pins or other types of metal contacts. Metal contacts 105 may be located in other places on the elongated cradle 104 and are configured to engage with one or more metal contacts on a head-wearable device. In some embodiments, metal contact 105A may be a positive contact, metal contact 105B may be a negative contact, and metal contact 105C may be a contact for data communication. Controller docks 106 and 108 are also shown in FIG. 1B. In the depicted example of FIG. 1B, controller dock 106 includes wireless-charging components 134, which may be included in one or both of controller docks 106 and 108, depending on the embodiment (and other embodiments may use metal-contact-based charging techniques).

FIGS. 1C and 1D show two additional views of an embodiment of the charging apparatus 100. FIG. 1C shows the charging apparatus 100 from a front-right view. Controller docks 106, 108 and elongated cradle 104 are connected to base 102. Elongated cradle 104 includes metal contacts 105 and protrusion 120. In FIG. 1C, controller dock 106 is shown with slip-resistant material 136. The slip-resistant material 136 may be included on a portion of controller dock 106 or may be included on more or less of controller dock 106 than shown in FIG. 1C. In some embodiments, slip-resistant material may also be included on other components, for example on at least a portion of controller dock 108 or at least a portion of elongated cradle 104.

FIG. 1D shows an embodiment of the charging apparatus 100 from a back-right view. Controller docks 106, 108 and elongated cradle 104 are connected to base 102. Elongated cradle 104 includes metal contacts 105 and protrusion 120. On the back edge 103B of base 102, a charging port 124 may also be included in the charging apparatus 100. The charging port 124 may be located elsewhere, including on other edges or portions (including a top or bottom surface) of the base or may be placed in or on another place or in another component (or the use of a charging port 124 may be replaced with (or supplemented by) a component used to wirelessly receive power from a power source). The example charging port 124 shown in FIG. 1D is a USB-C charging port, but the embodiments herein are not limited to just USB-C charging and other charging ports and charging technologies/methods are considered.

FIG. 1E shows an embodiment of the charging apparatus 100 from a front view. Controller docks 106, 108 and elongated cradle 104 are connected to base 102. Base 102 includes top surface 125, bottom surface 126, front edge 103A, and has a height or thickness 110. In some embodiments, at least a portion of bottom surface 126 may include a rubber coating, footing, or other slip-resistant material. Controller dock 106 is mounted such that there is an air gap 107 between the bottom surface of controller dock 106 and top surface 125 of base 102. Controller dock 108 is mounted such that there is an air gap 109 between the bottom surface of controller dock 108 and top surface 125 of base 102. In some embodiments, to help ensure mechanical stability when a headset and controllers are in their respective docked charging positions, the air gaps 107 and 109 are configured such that they are no more then 40-75% (and all values and smaller ranges therebetween) of the height or thickness 110 of the base.

FIG. 1F shows an embodiment of the charging apparatus 100 from a back view. Controller docks 106, 108 and elongated cradle 104 are connected to base 102. Base 102 includes back edge 103B, which includes charging port 124. Elongated cradle 104 includes metal contacts 105. Post 130 supports controller dock 108 and is configured to mount controller dock 108 to the base 102. Post 132 supports controller dock 106 and is configured to mount controller dock 106 to the base 102.

FIG. 1G shows an embodiment of the charging apparatus 100 from a bottom view. Bottom surface 126 of base 102 is shown. Portions of controller docks 106, 108, and a portion of elongated cradle 104 are also visible from the bottom view shown in FIG. 1G. The approximate location of the post 132 is also shown. As shown in FIG. 1G, post 132 is located approximately half way between the two parallel edges of the racetrack-shaped base. This is shown through arrows 133A and 133B, which have approximately the same length. The approximate location of cradle mount 128 is also shown. In some embodiments, cradle mount 128 is located closer to one parallel edge of the racetrack-shaped weighted base than the other parallel edge. This is shown, for example, through arrow 129B, which is shorter than arrow 129A. In some embodiments, the cradle may be located elsewhere.

FIG. 1H shows an embodiment of the charging apparatus 100. Cross-sectional view 170 demonstrates a view of the apparatus along the cross-sectional dotted line 171. Certain internal features of or within base 102 (e.g., support members, circuitry wires, etc.) have been omitted. As shown in cross-sectional view 170, controller dock 106 is supported by post 132. Air-gap 107 is created between the top surface 125 of base 102 and the bottom of controller dock 106. Cross-sectional view 172 demonstrates a view of the apparatus along the cross-sectional dotted line 173. As shown in cross-sectional view 172, controller dock 108 is supported by post 130. Air-gap 109 is created between the top surface 125 of base 102 and the bottom of controller dock 108.

FIG. 1I shows an embodiment of the charging apparatus, with cross-sectional view 174 taken along line and in the direction of arrows 175. Certain internal features of or within base 102 (e.g., support members, circuitry wires, etc.) have been omitted. As shown in cross-sectional view 174, base 102 includes electronics 160. A pivot means 162, such as a spring, is also shown, which is configured to allow the elongated cradle 104 to pivot, such as when the weight of the artificial-reality headset is received (which pivoting movement may help to ensure mechanical stability of the charging apparatus 100, while also helping to ensure that electrical contact is maintained between a charging portion of the headset and a portion of the elongated cradle 104). In some embodiments, base 102 includes an open space 164 that is configured to provide space for the elongated cradle to pivot forward and backwards. The depth 166 of the elongated cradle is also shown. Elongated cradle 104 is positioned above the top surface 125 of the base 102 such that an air gap 121 is created between the top surface 125 of base 102. As shown in FIG. 1I, at least two air gaps 121A, 121B may be created based on the dimensions and design of the elongated cradle 104.

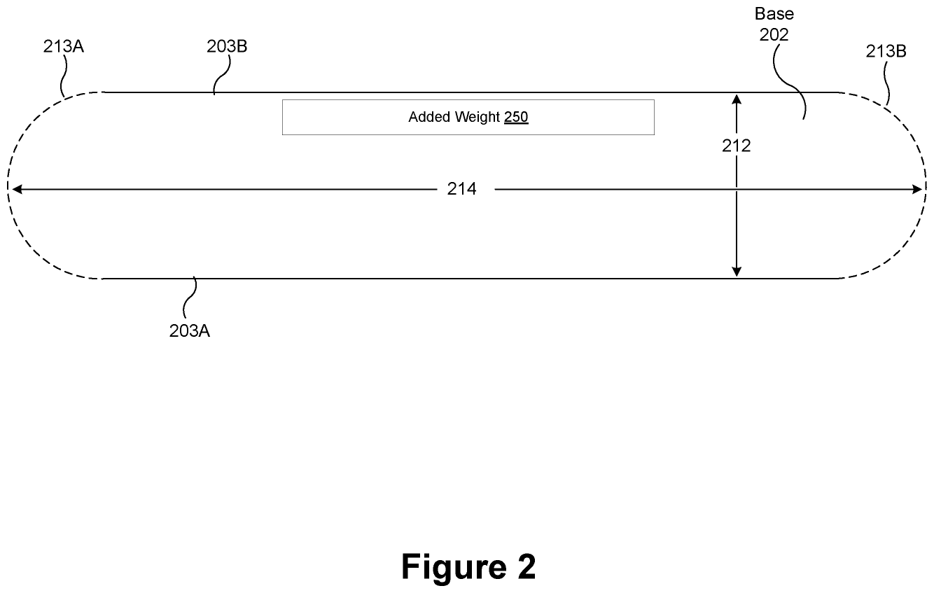

FIG. 2 shows an embodiment of the racetrack-shaped weighted base. The long axis 214 and short axis 212 of base 202 are shown. Parallel edge 203A and parallel edge 203B are connected by semi-circles 213A and 213B. The parallel edges 203A, 203B and semi-circles 213A, 213B form the racetrack-shape of the weighted base. In some embodiments, added weight 250 may be provided in the base. In some embodiments, the added weight 250 may be located at a location that is closer to one parallel edge (e.g., 203B) than the other (e.g. 203A), for example as shown in FIG. 2. In some embodiments, the added weight 250 may also be placed at other locations inside the base 202. In some embodiments, the base 202 may include one or more added weights.

In some embodiments, the added weight may dynamically move, for example to counterbalance weight of a headset, controller, or other accessories being charged or attached to components being charged. For example, if a headset with a larger, heavier, etc. strap is placed on top of the elongated cradle of the charger, the weight may be capable of moving dynamically to adjust the center of gravity of the charger to remain flat on the surface on which the charger is placed. In some embodiments, the weight may be movable based on a track or opening in which the weight is free to be moved. In some embodiments, the weight is moved mechanically. In some embodiments, a sensor is configured to detect or determine the current and/or optimal center of gravity. In some embodiments, the weight is moved in accordance with the sensor's detecting or determining of a preferred center of gravity.

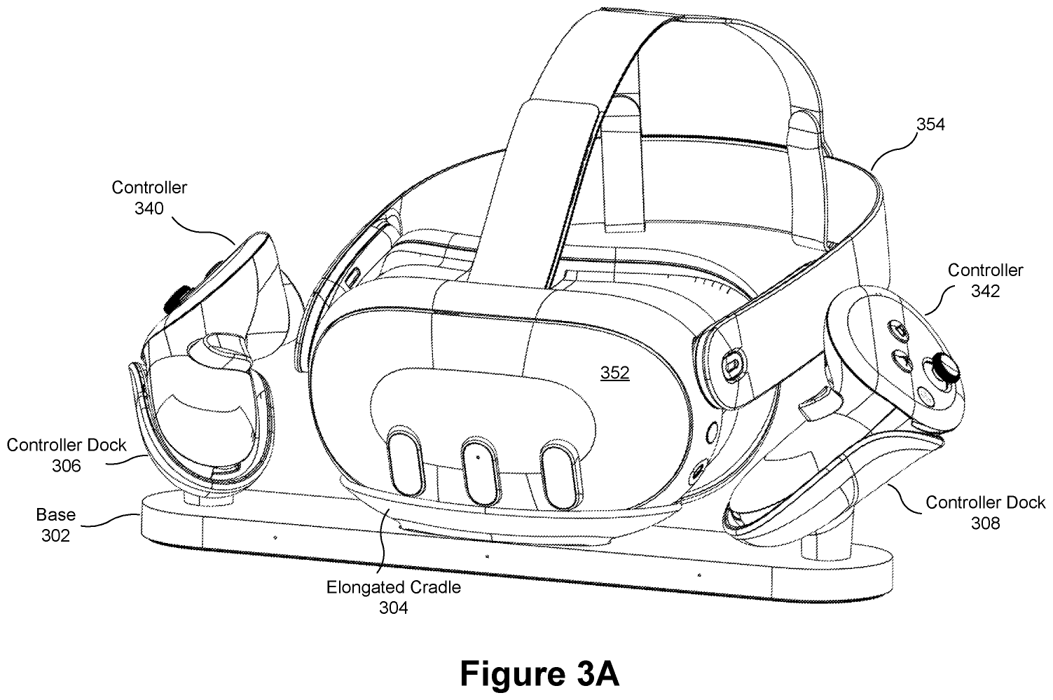

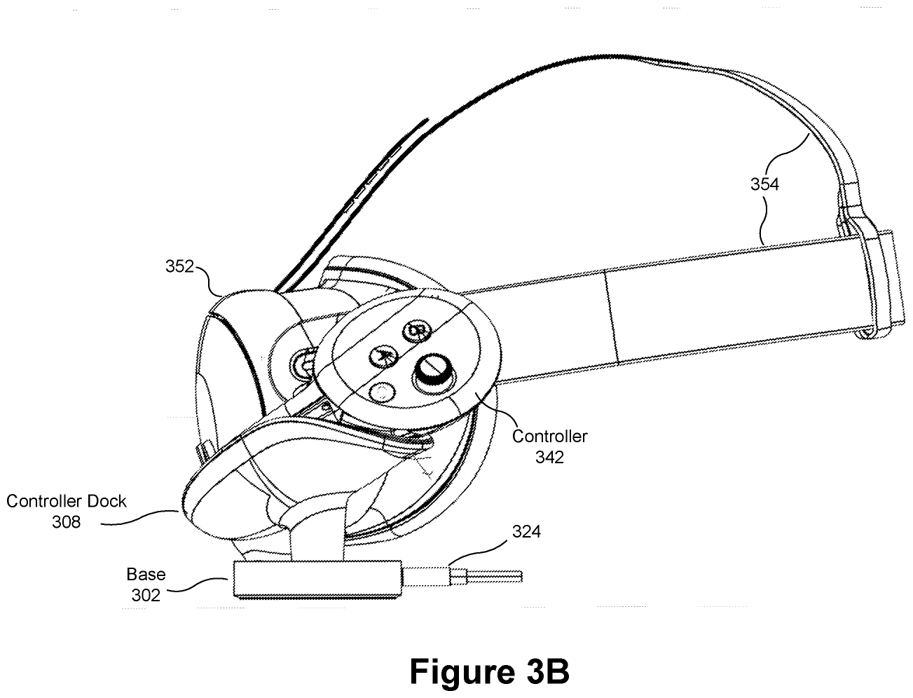

FIG. 3A shows a perspective view of a system that includes a head-wearable device 352 mounted on an embodiment of the charging apparatus. Head-wearable device 352 includes one or metal contacts configured to align with the one or more metal contacts of the charging apparatus. The metal contacts of the head-wearable device 352 may be included on the lower bottom side (for example metal contacts 505 shown in FIG. 5B), or may be included in other locations. Controller docks 306 and 308, base 302, and elongated cradle 304 of charging apparatus are also shown in FIG. 3A. Controller 340 is mounted on controller dock 306. Controller 342 is mounted on controller dock 308. Head-wearable device 352 includes head band 354 (which may also be referred to as a strap and is used to secure the head-wearable device 352 to a user's head when the artificial-reality headset is being used by the user; as noted previously, the racetrack-shaped weighted base described herein may be designed to accommodate many different strap types, including soft/hook-and-loop-fastener-based straps, straps with both soft and rigid components, and straps with mostly rigid components).

FIG. 3B shows a side view of a system that includes a head-wearable device 352 mounted on an embodiment of the charging apparatus. Controller dock 308 and base 302 are also shown in FIG. 3A. Controller 342 is mounted on controller dock 308. Head-wearable device 352 includes head band 354. In some embodiments, head band (also known as or referred to as a strap) 354 may be further down than as shown in FIG. 3B. For example, head band 354 may be at least partially resting on a surface, for example the surface on which the charging apparatus rests. In some embodiments, the elongated cradle is configured to pivot to maintain alignment and contact of the metal contacts of the head-wearable device and the metal contacts of the charging apparatus, even while the headset (and its associated strap) are in a docked position. In some embodiments, depending on a type of strap attached to the head-wearable device, the resting position of the charging apparatus may change (e.g., the charging apparatus may be configured not to tilt when a hook-and-loop-based fastener is attached as the strap, while the charging apparatus may be configured to tilt when a rigid (or at least partially rigid) unit is attached as the strap). A portion of a charging cable 324 is connected to the charging apparatus. The example charging cable is a USB-C charging cable, but is not limited to any particular charging connection or charging mechanism as discussed herein. Additional details regarding some embodiments of a charging apparatus with a pivoting structure are shown in, for example, FIGS. 5J-5L-2.

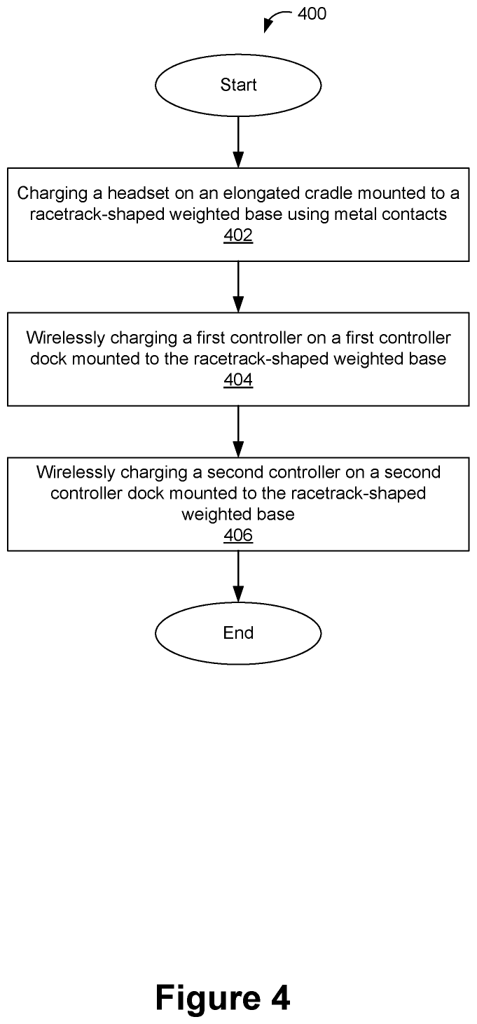

FIG. 4 provides a method 400 of performing steps of some embodiments of the charging apparatus. In step 402, a headset is charged on an elongated cradle that is mounted to a racetrack-shaped weighted base of the charging apparatus using metal contacts. In step 404, a first controller that is mounted to a racetrack-shaped weighted base is wirelessly charged on a first controller dock that is mounted to a racetrack-shaped weighted base. In step 406, a second controller is wireless charged on a second controller dock.

To provide a further examples, paragraphs preceded with A1-A16 (and B1-E1) below describe a more detailed example of a charging apparatus, system, and method.
(A1) In some embodiments, a charging apparatus comprises a racetrack-shaped weighted base, which includes a top surface and a bottom surface. The top surface and the bottom surface of the racetrack-shaped weighted base are both substantially flat. An elongated cradle is mounted to the racetrack-shaped weighted base. The elongated cradle is positioned above the top surface of the racetrack-shaped weighted base such that an air gap is created between part of a bottom surface of the elongated cradle and the top surface of the racetrack-shaped weighted base. The elongated cradle includes one or more metal contacts configured for charging a headset. The elongated cradle is also configured to align the one or more metal contacts with corresponding metal contacts on a portion of the headset that is received by the elongated cradle. The racetrack-shaped weighted base further comprises a first controller dock mounted to the racetrack-shaped weighted base. The first controller dock is positioned above the top surface of the racetrack-shaped weighted base such that an air gap is created between part of a bottom surface of the first controller dock and the top surface of the racetrack-shaped weighted base, and is configured for receiving and wirelessly charging a first controller. The racetrack-shaped weighted base further comprises a second controller dock mounted to the racetrack-shaped weighted base. The second controller dock is positioned above the top surface of the racetrack-shaped weighted base such that an air gap is created between part of a bottom portion of the second controller dock and the top surface of the racetrack-shaped weighted base, and is configured for receiving and wirelessly charging a second controller. This is shown, for example, in at least FIGS. 1A-1I, 5A-5L-2.

The term “racetrack” or “racetrack-shaped” as used in this specification is defined to mean a shape that includes two parallel lines that are adjacent to one another and that are connected to each other by an arc. An example racetrack-shaped base is shown in at least FIGS. 1A-1I and FIG. 2. The distance between the parallel lines, and the distance and size of the arc connecting the lines may vary. The racetrack-shaped weighted base may also be referred to as stadium-shaped, discorectangle-shaped, and sausage-body-shaped. Throughout the specification the base may be referred to as the racetrack-shaped weighted base, the weighted base, the base, or otherwise. As used in the specification, the reference to any of these terms to define the base for certain embodiments should not be a limitation on the other embodiments as described herein as many of the other embodiments may employ a base of another shape (such as circular, ovular (e.g., with rounded sides as compared to the parallel sides for the certain embodiments described herein), etc.).

As compared to certain charging dockets, the charging apparatus described herein has both structural and functional improvements. For example, the use of wireless charging for the controllers, the use of a racetrack-shaped base as compared to a rectangular base, which racetrack-shaped base is also weighted to ensure that the charging apparatus does not fall over when a headset that includes a strap is in a charging position (e.g., the weighted base counteracts weight from the strap to balance the charging apparatus). The weighted base may include weight that is added to the base in addition to the weight of the components and materials that make up, or are attached to, the weighted base. The weight in the base may be located at one or more locations that act to counterbalance the weight of a headset and any accessories (e.g., head strap, headphones, etc.) attached thereto. For example, the weight may be located closer to the side of the base where the elongated cradle is mounted, such that the weight is located further from the center of gravity of the headset and any attached accessories. The weight may also be distributed in many other ways. In some embodiments, the amount of weight added to the base is between 200-600 grams. In some embodiments, the base may also make use of wings or extendable protrusions (that may or may not include added weight) that extend upwardly from a surface of the weighted base to help further counterbalance heavier strap accessories (e.g., the wings may be optionally extended by a user if they are utilizing the charging dock with a heavier strap accessory, but the wings do not necessarily need to be in their respective extended states).

In some embodiments, the base is substantially flat such that the top surface and the bottom surface have an angle (e.g., between a lowermost point and an uppermost point of the top or bottom surface) of no more than 0-5 degrees from a perfectly planar surface. In some embodiments, the top surface is less or more planar than the bottom surface. In some embodiments, the top and bottom surfaces have an angle of no more than 10 degrees.

Certain charging docks are designed such that substantially all of the bottom portion of a headset rests flat on the base (e.g., these certain charging docks may have a unibody design in which there are no gaps between what defines a base and what defines charging positions for the accessories to be charged). In some embodiments, the charging apparatus is designed such that the cradle is designed to receive only a portion of the headset. In some embodiments, the portion of the headset that is received by the cradle is the front bottom corner of the headset, but the portion received by the cradle may extend further up the front or further underneath the headset. The cradle may receive other portions of the headset, such as the top, side, bottom, or front of the headset. In some embodiments, the charging apparatus is designed such that less than the entire, or substantially all of the, bottom surface of the headset rests on the base of the charging apparatus.

In some embodiments, the elongated cradle is mounted to the weighted base. The location of the mounting may depend based on a particular embodiment. For example, the elongated cradle may be mounted at a position that is closer to one of the parallel edges of the racetrack-shaped weighted base than the other. In some embodiments, the elongated cradle may be mounted at a location that is approximately 75% of the way between the two parallel edges of the racetrack-shaped weighted base. By way of a non-limiting example, if the distance from a first parallel edge of the racetrack-shaped weighted base to a second parallel edge of the base is 10 cm (100 mm), an elongated cradle mounted approximately 75% of the way between the two edges means that the elongated cradle is mounted at a location that is 7.5 cm from a first parallel edge and 2.5 cm from a second edge. In some embodiments, the elongated cradle may be mounted at a location between 70-90% of the way between the two parallel edges. In some embodiments the elongated cradle may be mounted at a location that is greater than 70% of the way between the two parallel edges.

In some embodiments, the elongated cradle may be mounted at a position that is approximately half-way between the two parallel edges of the racetrack-shaped weighted base. Approximately half-way may be understood in some embodiments to mean a location that is 40-60% in the middle of the base. By way of a non-limiting example, if the distance from a first parallel edge of the racetrack-shaped weighted base to a second parallel edge of the base is 10 cm (100 mm), then a component that is mounted approximately half-way between the two parallel edges may be placed anywhere from 4 cm (40 mm) from the first parallel edge to 6 cm (60 mm) from the first parallel edge. These measurements are used only by way of example and the distance between the two parallel edges of the racetrack-shaped weighted base may be less or more than 10 cm.

In some embodiments, the elongated cradle is also positioned entirely above the top surface of the racetrack-shaped weighted base. In such an embodiment, where the elongated cradle is entirely above the top surface of the racetrack-shaped weighted base, the elongated cradle may be mounted to the racetrack-shaped weighted base and therefore the component configured to mount the cradle to the weighted base may contact, or extend below, the top surface of the base. In some embodiments, the elongated cradle itself (not the mounting component) may be positioned such that the bottom portion of the cradle is above the top surface of the base. Such a positioning may create an air gap between the bottom of the cradle and the top surface of the base. In some embodiments, the cradle may create an air gap when no headset is resting on the cradle, but, when a headset is resting on the cradle, one edge of the cradle may touch the top surface of the base such that there is no air gap on one side of the elongated cradle. In some embodiments, the air gap will remain at all locations under the elongated cradle when the headset is resting on the cradle.

In some embodiments, the bottom surface of the cradle may have a different configuration or design. Such a design may be dependent on the design of the cradle itself and/or the way in which the cradle interacts, supports, and charges the headset or the design of the bottom portion of the cradle may be dependent on other factors, such as weight distribution or other factors.

In some embodiments, the elongated cradle (e.g., elongated along one dimension such that a first dimension (a semi-major axis, such as width or the longer dimension of an ellipse) of the cradle is greater than a second dimension (e.g., a semi-minor axis, such as length or the shorter dimension of an ellipse) of the elongated cradle) includes one or more metal contacts configured for charging a headset. In some embodiments, the one or more metal contacts are pogo pins. The designs of the pogo pins may vary depending on the embodiment, for example the design of the pogo pins may be one of the following designs: Bias Tail, Back Drill, Cone Design, or Ball Design. Other pogo pin designs may also be considered and utilized. In some embodiments, all of the pogo pins have the same design. In some embodiments, each of the pogo pins may have different designs. In some other embodiments, the one or more metal contacts are elongated metal contacts that are made of a particular shape such that they interface with one or more contacts on a headset at more than one position along the metal contact(s) (e.g., there is not a single contact point, but multiple contact points). In some other embodiments, the metal contacts are ovular shaped, racetrack-shaped, circular shaped, or may be other shapes. In some embodiments, the cradle is configured to align the one or more metal contacts with corresponding metal contacts on a portion of the headset that is received by the elongated cradle. In some embodiments, there are at least three metal contacts, where a first metal contact is for communicating data (e.g., a data line for communicating a charging status, charging characteristics (e.g., voltage, etc.), etc.), a second metal contact is a positive contact or terminal, and a third metal contact is a negative contact or terminal. In some embodiments, a ground terminal may also be included. The ground terminal may replace one of the three aforementioned contacts or may be added as a fourth metal contact. These contacts/terminals may be used in other configurations as well.

In some embodiments, the weighted base has at least one controller dock. In some embodiments, the weighted base has at least two controller docks. A controller dock may be mounted to the weighted base. The way in which the controller dock is mounted to the weighted base may be similar to, or may be different from, the mounting of the elongated cradle to the weighted base. In some embodiments, the controller dock is positioned entirely above the top surface of the weighted base. In such an embodiment, where the controller dock is entirely above the top surface of the weighted base, the controller dock may be mounted to the weighted base and therefore the component configured to mount the controller dock to the weighted base may contact, or extend below, the top surface of the base. In some embodiments, the controller dock itself (not the mounting component) may be positioned such that the bottom portion of the controller dock is above the top surface of the base. Such a positioning will create an air gap between the bottom of the controller dock and the top surface of the base.

In some embodiments, the bottom surface of the controller dock may have a different configuration or design. Such a design may be dependent on the design of the controller dock itself and/or the way in which the controller dock interacts, supports, and charges the controllers or the design of the bottom portion of the controller dock may be dependent on other factors, such as weight distribution or other factors.

In some embodiments, a first controller dock is configured for charging a first controller, and a second controller dock is configured for charging a second controller. In some embodiments, the first controller dock is designed to receive and charge only the first controller. In some embodiments, the second controller dock is designed to receive and charge only the second controller. In some embodiments, the first and/or second controller docks are configured to receive and charge both a first and a second controller.

In some embodiments, the controller docks are configured for wirelessly charging a controller. In some embodiments, the controller docks are configured for charging a controller through the use of metal contacts or other charging techniques.
(A2) In some embodiments of A1, the elongated cradle is further configured to be pivotable at a point where the elongated cradle is mounted to the racetrack-shaped weighted base such that the one or more metal contacts are aligned with corresponding metal contacts on the portion of the headset that is received by the elongated cradle. This is shown, for example, in at least FIGS. 1I and 5I-5L-2.

In some embodiments, the elongated cradle is pivotable. The pivotable elongated cradle may operate such that, when a headset is placed on the cradle, the cradle pivots in response to the weight of the headset. This may be especially helpful when a headset includes various accessories that are heavier than a fabric strap—for example a hard strap, headphones, or other accessories that may be attachable to the headset—that shifts the center of gravity of the headset. The pivoting cradle may enable the metal contacts of both the headset and the cradle to be more securely and confidently connected, even while the headset is connected with different types of accessories having different weights at different points in time. It may be that, without such a pivot, the headset's weight would force the headset to be dislodged from the charging contacts and the headset would not actually be charging. In some embodiments, a position of the elongated cradle when no component is placed in the cradle can be referred to as a first position; and a position of the elongated cradle when a component has been placed in the cradle and the cradle has pivoted can be referred to as a second position. In some embodiments, a second position may be the position at which the elongated cradle has pivoted as much as allowed, for example because the cradle has pivoted through an open space available to the elongated cradle for pivoting (e.g., open space 164 in FIG. 1I or open space 564 in FIG. 5I), as shown for example in FIGS. 5J-5L-2.

In some embodiments, the pivot of the cradle may be achievable through a spring loaded pivot system. In some embodiments, the pivot may be achieved through other mechanisms. The resistance of the pivot may change depending on the embodiments, the headset for which the charger is designed, the size of the contacts, or otherwise. In some embodiments the spring force of the spring that is communication with the cradle and that is configured to enable the cradle to pivot is adjusted to ensure an optimal docking experience. For example, the spring force is designed to not be too high such that the metal contacts do not engage between the headset and the elongated cradle, the dock does not tilt back when desired, or the headset is close to being propelled out of the cradle. The spring force also should not be too low such that the metal contacts do not engage between the headset and the elongated cradle, the elongated cradle will not return to its original place when a headset is removed, or that when the headset is placed in the cradle there is no (or substantially no) resistance supporting the headset. In some embodiments, the optimal spring force ranges between 200 g and 450 g. In some embodiments, the cradle can pivot forward and backward.
(A3) In some embodiments of A1-A2, the charging apparatus further comprises a spring in communication with the elongated cradle; wherein the spring is configured to allow the elongated cradle to pivot between at least a first position and a second position; and wherein the spring has a spring force of between 200-450 g. This is shown, for example, in at least FIGS. 1I, 5I-5L-2.
(A4) In some embodiments of A1-A3, the one or more metal contacts configured for charging the headset are pogo pins. This is shown, for example, in at least FIGS. 1B-1D, 5B-5C.

In some embodiments, using the pivotable version of the elongated cradle (which was discussed above), the pogo pins all have a substantially circular or square shape and the pivoting of the elongated cradle ensures that the circular-shaped or square-shaped pogo pins are always aligned when the portion of the headset is received by the elongated cradle.
(A5) In some embodiments of A1-A4, the one or more metal contacts include at least three metal contacts. A first metal contact of the at least three metal contracts is configured for communicating data, a second metal contact of the at least three metal contracts is configured to be a positive contact, and a third metal contact of the at least three metal contracts is configured to be a negative contact. This is shown, for example, in at least FIGS. 1B-1D, 5B-5C.
(A6) In some embodiments of A1-A5, a depth of the elongated cradle is between 15-35 millimeters. This is shown, for example, in at least FIGS. 1I and 5I.

In some embodiments, the depth of the elongated cradle may be larger or smaller than as shown in the figures. In some embodiments, the cradle may have a depth of between 15-35 mm. The elongated cradle may also have other depths. For example, in some embodiments, the cradle may have a depth of approximately 28-32 mm. In some embodiments, the cradle may include a hook, lip, indent, or protrusion (e.g., nose protrusion), as discussed elsewhere in this specification.

In some embodiments, the cradle is generally an elliptical shape. The “depth” of the cradle is the distance of the short axis. The depth is generally measured in a straight line from the top of the center of one lip of the elongated cradle to the top of the center of the opposite lip of the elongated cradle. The depth is generally not measured as the surface area distance from one lip to the other. This measurement is shown in FIGS. 1I and 5I (e.g., depth measurement 166).
(A7) In some embodiments of A1-A6, the elongated cradle is configured to charge the headset without using a magnetic-coupling structure. This is shown, for example, in at least FIGS. 1B, 3A-3B, and 5B-5C.

As compared to certain charging docks, the charging apparatus may be configured to receive, position, and charge components without the use of a magnetic coupling structure.

In some embodiments, wireless charging of the controllers may be conducted using a non-Qi compliant charging mechanism, such as a charging mechanism that uses coils that are non-planar (e.g., coils the curve around the housing of the controller's handle and also curve around a portion of the charging dock that is holding the controller). In some embodiments, the wireless charging of the controllers may be conducted using a Qi compliant charging mechanism.
(A8) In some embodiments of A1-A7, the elongated cradle is mounted to the racetrack-shaped weighted base at a position that is closer to a first parallel edge of the racetrack-shaped weighted base than a second parallel edge of the racetrack-shaped weighted base that is opposite to the first parallel edge. This is shown, for example, in at least FIGS. 1A-1D, 1G, 1I, 5A-5D, 5G, and 5I.

The first parallel edge may be the backmost parallel edge (e.g., edge 103A in FIG. 1B and edge 203A in FIG. 2) and the second parallel edge may be the frontmost parallel edge (e.g., edge 103B in FIG. 1B and edge 203B in FIG. 2).
(A9) In some embodiments of A1-A8, the headset further includes a headset-strap, and the elongated cradle is further configured to charge the headset while it is coupled with the headset-strap when at least a portion of the headset-strap of the headset rests on a separate surface. This is shown, for example, in at least FIGS. 3A-3B.

As discussed elsewhere in this specification, in some embodiments, the headset may include one or more accessories, including different straps, headphones, and otherwise. One such accessory is a hard strap a user may use to secure the headset on the user's head. The hard strap may include a hard ovular strap designed to encircle the user's head. On the rear of the strap—for example the portion of the strap that is on the back of a user's head and opposite the headset—there may be a cup-like structure designed to conform to a user's head. The charging apparatus may be designed such that elongated cradle is configured to receive and charge the headset when any type of accessory is applied. This includes the cradle being configured to receive the headset when a hard strap is attached such that the headset rests partially on the cradle and the back portion of the headset (whether it be the strap itself, a cup-like structure, or some other structure or portion of the strap, including headphones or other structures) rests on a surface, such as a table of surface on which the charging apparatus is located.
(A10) In some embodiments of A1-A9, the racetrack-shaped weighted base is no more than 15 millimeters thick.

In some embodiments, the thickness of the racetrack-shaped weighted base is no more than 15 millimeters (e.g., approximately 13 mm, but ranges between 5-20 millimeters (and narrower ranges within this range) may also be contemplated for other embodiments). In some embodiments, the thickness of the racetrack-shaped weighted base is approximately 12 mm. With respect to this measurement, thickness refers to the vertical distance between the top surface of the racetrack-shaped weighted base and the bottom surface of the racetrack-shaped weighted base, an example thickness is labelled as thickness 110 in FIGS. 1A, 1E, 5A, and 5E.
(A11) In some embodiments of A1-A10, the racetrack-shaped weighted base further includes a plurality of lights, wherein the plurality of lights includes a first light operatively associated with the elongated cradle, positioned next to the elongated cradle along the racetrack-shaped weighted base, and configured for indicating a headset-charge status of the headset. A second light of the plurality of lights is operatively associated with the first controller dock, positioned next to the first controller dock along the racetrack-shaped weighted base, and configured for indicating a first controller-charge status of the first controller. A third light of the plurality of lights a third light operatively associated with the second controller dock, positioned next to the second controller dock along the racetrack-shaped weighted base, and configured for indicating a second-controller charge status of the second controller. This is shown, for example, in at least FIGS. 1A, 1E, 3A, 5A, and 5E.

In some embodiments, the base includes one or more lights. In some embodiments, the lights are used to indicate the charging status of one or more of the components. In some embodiments, the lights are LEDs. In some embodiments, there are at least three lights where a first light indicates the charging status of at least the elongated cradle or headset charging therein, a second light indicates the charging status of the first controller dock or the controller charging therein, and a third light indicates the charging status of the second controller dock or the controller charging therein. In some embodiments, the lights may change color based on the charging status of the associated component—for example, a red light may indicate that a component is out of battery (e.g., less than 10%), an orange light may indicate that a component is charging, and a green light may indicate that a component has a fully charged battery (e.g., more than 95% charge). Other lights and corresponding charge levels and statuses are also contemplated. The lights may also indicate charge status thorough more than just the color, including flashes, or a certain flashing rhythm.

These lights may also be used to indicate more than just charge status. For example, they may be used to indicate that a component is not properly seated in the charging cradle or docks, that an update is available for the charging apparatus or the components being charged. Still other examples may include one or more lights to indicate that the internal battery of the component is nearing the end of its lifespan or that other maintenance is required.

In some embodiments, one or more lights may further be configured for many other purposes. For example, the charging apparatus may include circuitry configured to connect-wirelessly or through metal contacts or otherwise—to the headset and controllers. The charging apparatus may be configured through the one or more lights to display a message to the user through colored or flashing lights, or through text. The headset may be configured to recognize or be programmed to store multiple user profiles. The charging apparatus may be configured to include text recognizing and acknowledging a certain user, for example with a message—WELCOME USER 1! Other examples may include when a user puts the headset and/or controllers back on the charging apparatus, the charging apparatus may include text or another message communicating achievements or other information to the user.

Some embodiments may make use of one light that indicates an aggregate charging status for the headset as well as the two different controllers, e.g., an average of all three or a weighted average of all three.

In some embodiments, one or more LEDs may flash if a foreign object is detected. For example, if an object or device is detected, but the object or device is not the correct device—e.g., a non-compatible HMD is placed in the HMD cradle or charger, a non-compatible controller is placed on the controller dock, a left controller is placed on the charger for the right controller—the LED associated with the dock or cradle on which a foreign or incompatible device was placed may flash one or more colors or with one or more flashing cadences. In some embodiments, one or more LEDs may flash or display one or more colors or one or more flashing cadences if one or more components (e.g., HMD or controllers) are not properly aligned the charging contacts or components of the charging apparatus (e.g., elongated cradle or controller docks). In some embodiments, one or more LEDs may flash if the power from a charging cable or other power source is too high or too low. In some embodiments, the optimal range for power supply to the charging base is between 13-33 Watts. In some embodiments a solid light will appear when charging. In some embodiments, a flashing light with a different flashing cadence (e.g., slower flashing) from a flashing light when an error exists (e.g., foreign objects are detected, too much or too little power, etc.) will appear when the system is properly charging one or more of the corresponding component of a controller or HMD. In some embodiments a solid light will appear when a corresponding component is fully charged. In some embodiments, for the HMD charging cradle, if one or more of the charging contacts is not properly aligned or does not have the appropriate level of contact to charge, communicate data, etc., one or more LEDs may flash according to the same or different flashing cadence(s) as previously described. In some embodiments, one or more of the flashing cadences may be replaced with (or supplemented by) different light colors. In some embodiments, the flashing cadences or colors are configurable by the user or manufacturer.
(A12) In some embodiments of A1-A11, the racetrack-shaped weighted base further includes an added weight in addition to the weight of a housing of the racetrack-shaped weighted base. The added weight may be at least 300 grams. This is shown, for example, in at least FIG. 2.
(A13) In some embodiments of A1-A12, the first controller dock is mounted on a first side of the elongated cradle; and the second controller dock is mounted on a second side of the elongated cradle. In some embodiments, the second side of the elongated cradle is substantially opposite the first side of the elongated cradle. This is shown, for example, in at least FIGS. 1A-D, and 5A-5D.

In some embodiments, the first and second controller docks may be located on opposite sides of the weighted base. For example, in some embodiments the elongated cradle is positioned in the center of the two controller docks. The first controller dock may be positioned on one side of the elongated cradle. The second controller dock may be positioned on a second side of the elongated cradle. In some embodiments, the first and second sides of the elongated cradle are substantially opposite. By substantially opposite, it is meant that, if a line was drawn down the short axis of an elliptically-shaped elongated cradle, one controller dock would be to the right of that line and one controller dock would be to the left of that line.
(A14) In some embodiments of A1-A13, the first controller dock is mounted to the racetrack-shaped weighted base at a location that is substantially half-way between a first parallel edge of the racetrack-shaped weighted base and a second parallel edge of the racetrack-shaped weighted base. The second controller dock is mounted to the racetrack-shaped weighted base at a location that is substantially half-way between the first parallel edge of the racetrack-shaped weighted base and the second parallel edge of the racetrack-shaped weighted base. The first parallel edge of the racetrack-shaped weighted base is opposite to the second parallel edge of the racetrack-shaped weighted base. This is shown, for example, in at least FIGS. 1A-1G, and 5A-5G.

In some embodiments, the controller docks are mounted at a location that is substantially half way between the two parallel edges of the racetrack-shaped weighted base. In other words, the controller docks are mounted along, or substantially along, the long axis of the racetrack-shaped weighted base. Similar to a discussion elsewhere in the specification, substantially half-way between the first and second parallel edges may mean a location that is 40-60% in the middle of the base.
(A15) In some embodiments of A1-A14, the first controller dock further includes slip-resistant material configured to position the first controller; and the second controller dock further includes slip-resistant material configured to position the second controller. This is shown, for example, in at least FIG. 1C.

In some embodiments, the controller docks include slip-resistant material that is configured to hold the controllers in place in the controller docks. This material may assist with aligning the appropriate portion of the controller with the appropriate portion of the controller dock. Or may also assist with ensuring an appropriately snug fit in the controller dock. Or may also assist with ensuring the controllers do not slip out of the appropriate position or the controller dock completely. Example material may include rubber or other materials.
(A16) In some embodiments of A1-A15, the first controller dock is further configured to position the first controller through a gravity-hold mechanism; and the second controller dock is further configured to hold the second controller through a gravity-hold mechanism. This is shown, for example, in at least FIGS. 1A, 3A-3B, 5A-5F, and 5H.

In some embodiments, the controller docks may be configured to hold a controller through gravity. The controller docks may configured in this way through the positioning, design, or angle of the dock. The controller dock may be designed such that, when a controller is placed on the controller dock, the design of the controller dock allows the controller to sit correctly in the controller dock. The weight and design of both the controller dock and controller are designed to facilitate this.

In some embodiments, the gravity-hold mechanism does not rely on a magnet to position a controller. In some embodiments, the gravity-hold mechanism relies on the geometric shape of the controller dock and controller such that the center of gravity of the controller is designed to self-correct and come to rest in a desired point or location on the controller dock. The edges of the controller dock are designed such that they are smooth and will encourage the controller to automatically and correctly align the controller on the controller dock. The controller is similarly designed such that the edges of the controller act to guide the controller's center of gravity to a particular point or location on the controller dock. In some embodiments, the optimal area of the controller dock at which the center of gravity comes to rest is a circular area with a diameter of between 0.1-3 mm. In some embodiments, the area is larger, for example between 2-10 mm. In some embodiments, the optimal area is rectangular such that it covers a horizontal (or vertical, diagonal, etc.) portion of the controller dock. This is shown, for example, in FIG. 5B.
(A17) In some embodiments of A1-A16, the first controller dock further includes a non-stick material configured to position the first controller, and the second controller dock further includes a non-stick material configured to position the second controller. In some embodiments, the non-stick material is a cloth or other fabric that enables a controller to efficiently and effectively slide into place, for example through the use of a gravity-hold mechanism as discussed above and elsewhere in this specification. The non-stick material may be located on some or all of the controller dock. This is shown, for example, in FIG. 5C.
(A18) In some embodiments of A1-A17, the elongated cradle further includes at least one protrusion that is configured to align with an indent of the headset. This is shown, for example, in at least FIGS. 1A, 1C-1D, 5A, and 5C-D.
(A19) In some embodiments of A1-A18, the protrusion of the elongated cradle includes a lip that is configured to interact with a recess on the indent of the headset. This is shown, for example, in at least FIGS. 5A, 5C-D, 5I, and 5K-1-5K-2.

In some embodiments, the lip (or recess or overhang or edge) of the protrusion on the elongated cradle and the lip (or recess or overhang or edge) on the indent of the headset lock onto each other. This design allows a user to easily position the headset on the elongated cradle and to also easily disconnect or remove the headset.
(B1) In accordance with some embodiments, a system includes a charging apparatus, a headset, at least a first controller associated with the headset, and at least a second controller associated with the headset, the charging apparatus configured in accordance with any of the embodiments A1-A19. This is shown, for example, in at least FIGS. 3A-3B, and 5A-5B.
(C1) In accordance with some embodiments, a method of using the charging apparatus of any of the embodiments A1-A19 to charge at least a first controller and a second controller associated with the headset is provided. This is shown, for example, in at least FIGS. 1A-3B, 5A-5L-2.
(D1) In accordance with some embodiments, a non-transitory, computer-readable storage medium includes instructions that, when executed by the charging apparatus of any of the embodiments A1-A19, causes the charging apparatus device to facilitate charging of one or more of a headset, a least a first controller associated with the headset, and a second controller associated with the headset. This is shown, for example, in at least FIGS. 1A-1I, 3A-B, 5A-5I.
(E1) In accordance with some embodiments, a charging device comprises a racetrack-shaped weighted base, including a top surface and a bottom surface, wherein the top surface and the bottom surface of the racetrack-shaped weighted base are both substantially flat. A headset-charging means is mounted to the racetrack-shaped weighted base, the headset-charging means being positioned entirely above the top surface of the racetrack-shaped weighted base such that an air gap is created between part of a bottom surface of the headset-charging means and the top surface of the racetrack-shaped weighted base. The headset-charging means includes a first charging means configured for charging a headset, and is configured to align the first charging means with corresponding second charging means on a portion of the headset that is received by the headset-charging means. The racetrack-shaped weighted base further comprises a first controller-charging means mounted to the racetrack-shaped weighted base, the first controller-charging means being positioned entirely above the top surface of the racetrack-shaped weighted base such that an air gap is created between part of a bottom surface of the first controller-charging means and the top surface of the racetrack-shaped weighted base, and configured for receiving and wirelessly charging a first controller. The racetrack-shaped weighted base further comprises a second controller-charging means mounted to the racetrack-shaped weighted base, the second controller-charging means being positioned entirely above the top surface of the racetrack-shaped weighted base such that an air gap is created between part of a bottom portion of the second controller-charging means and the top surface of the racetrack-shaped weighted base, and configured for receiving and wirelessly charging a second controller. This is shown, for example, in FIGS. 1A-1I and 3A-3B, and 5A-5I.

Having thus described FIGS. 1-4, as well as various example aspects of A1-E1 above, certain system-level block diagrams (depicting components used with the impedance-stabilizing techniques discussed herein) will now be described.

FIGS. 5A-5L-2 illustrate different views of an example charging apparatus in accordance with some embodiments. FIGS. 5A-5I illustrate similar views as the views of the embodiments described with respect to FIGS. 1A-1I. It is contemplated that the components and other aspects of the embodiments discussed with respect to FIGS. 5A-5L-2 can be modified in view of, added to, or otherwise combined with the embodiments described with respect to FIGS. 1A-1I, and vice-versa. FIGS. 5A-5L-2 may also include references to certain example elements or features that may be included in certain locations or in certain components, or that may be excluded or at different locations in different embodiments, as a skilled artisan will understand upon reading this detailed description.

FIG. 5A shows a front view of an example embodiment of the charging apparatus 500. Charging apparatus 500 includes a base 502, an elongated cradle 504, controller dock 506 (which may be referred to as a first controller dock), and controller dock 508 (which may be referred to as a second controller dock). Base 502 has a thickness or height 510, top surface 525, and three lights 522A-522C. Elongated cradle 504 is attached to the base 502 through cradle mount 528. The cradle mount 528 may be rigid, pivotable, or otherwise adjustable, for example to better support and maintain a consistent charging connection between a head-wearable device and the elongated cradle 504. In some embodiments, one or more of the controller docks 506, 508 may be also be pivotable. For example, the controller docks 506, 508 may be pivotable at the location where posts 532, 530 (respectively) meet base 502, or where the posts meet the cradle portion of the controller docks.

Controller dock 506 is attached to the base 502 through post 532. Controller dock 508 is attached to base 502 through post 530. Controller docks 506 and 508 are positioned such that the bottom surface of controller dock 506 and the bottom surface of controller dock 508 are separated from, and above, the top surface 525 of base 502, such that an air gap is created between the controller docks 506, 508 and the base 502. As shown in FIG. 5A, air gap 507 separates the bottom portion of the controller dock 506 from the top surface 525 of the base 502. Air gap 509 similarly separates the bottom portion of the controller dock 508 from the top surface 525 of the base 502. In some embodiments, the air gaps 507, 509 may be between 5-15 mm. In the depicted example of FIG. 5A, the air gaps 507 and 509 are of a same size, but other embodiments are also contemplated in which the air gaps 507 and 509 may be differently sized (e.g., one of the air gaps may be between 0.5-5 mm larger or smaller than the other air gap).

Lights 522A-522C are positioned in the base 502 to indicate charge status, device compatibility, error or information messages, or otherwise as discussed elsewhere in this specification.

FIG. 5B shows a top view of an embodiment of the charging apparatus 500. Base 502 includes two substantially parallel (e.g., within +/−5 degrees of parallel) edges-front edge 503A and back edge 503B. The depth 512 of the base 502, defined as the distance between the parallel edges 503A and 503B, is also shown in FIG. 5B. The elongated cradle 504 further includes metal contacts 505, which may include three separate metal contacts 505A-505C. The metal contacts 505 are described elsewhere in this specification, for example with respect to FIG. 1B and the various embodiments discussed herein. In the depicted example of FIG. 5B, controller dock 506 includes wireless-charging components 534, which may be included in one or both of controller docks 506 and 508, depending on the embodiment (and other embodiments may use metal-contact-based charging techniques).

FIGS. 5C and 5D show two additional views of an embodiment of the charging apparatus 500. FIG. 5C shows the charging apparatus 500 from a front-right view. Controller docks 506, 508 and elongated cradle 504 are connected to base 502. Elongated cradle 504 includes metal contacts 505 and protrusion 520. In FIG. 5C, controller dock 506 is shown with a non-stick material 537. The non-stick material 537 may be included on a portion of controller dock 506 or may be included on more or less of controller dock 506 than shown in FIG. 5C. In some embodiments, the non-stick material 537 may also be included on other components, for example on at least a portion of controller dock 508 or at least a portion of elongated cradle 504. In some embodiments, the non-stick material 537 is a cloth or other fabric that enables a controller to better slide into place through the use of a gravity-hold mechanism such that when a controller is placed in a controller dock, the controller will automatically correct its position so that the controller is correctly seated in the controller dock. In some embodiments, where a controller dock includes wireless charging components, the gravity-hold mechanism will likewise align the wireless charging components of the controller and the controller dock. The gravity-hold mechanism is also discussed elsewhere in this specification.

FIG. 5C further shows a lip 523 on protrusion 520 of the elongated cradle 504. In some embodiments, the lip 523 may be between 0.5-10 mm. In some embodiments the lip 523 may be between 1-3 mm. The lip 523 may be designed to engage with a corresponding lip (or edge or recess) on a nose indent of the headset. The lip of the protrusion 520 and the lip of a headset are discussed elsewhere and are designed to engage to enable a more secure connection while also allowing for easy attachment and removal of the headset.

FIG. 5D shows an embodiment of the charging apparatus 500 from a back-right view. Controller docks 506, 508 and elongated cradle 504 are connected to base 502. Elongated cradle 504 includes metal contacts 505 and protrusion 520 with lip 523. On the back edge 503B of base 502, a charging port 524 may also be included in the charging apparatus 500.

FIG. 5E shows an embodiment of the charging apparatus 500 from a front view. Controller docks 506, 508 and elongated cradle 504 are connected to base 502. Base 502 includes top surface 525, bottom surface 526, front edge 503A, and has a height or thickness 510. Controller dock 506 is mounted such that there is an air gap 507 between the bottom surface of controller dock 506 and top surface 525 of base 502. Controller dock 508 is mounted such that there is an air gap 509 between the bottom surface of controller dock 508 and top surface 525 of base 502. In some embodiments, to help ensure mechanical stability when a headset and controllers are in their respective docked charging positions, the air gaps 507 and 509 are configured such that they are no more then 40-75% (and all values and smaller ranges therebetween) of the height or thickness 510 of the base. In some embodiments, the air gaps 507 and 509 may be larger than the height 510 of the base.

FIG. 5F shows an embodiment of the charging apparatus 500 from a back view. Controller docks 506, 508 and elongated cradle 504 are connected to base 502. Base 502 includes back edge 503B, which includes charging port 524. Elongated cradle 504 includes metal contacts 505. Post 530 supports controller dock 508 and is configured to mount controller dock 508 to the base 502. Post 532 supports controller dock 506 and is configured to mount controller dock 506 to the base 502.

FIG. 5G shows an embodiment of the charging apparatus 500 from a bottom view. Bottom surface 526 of base 502 is shown. Portions of controller docks 506, 508, and a portion of elongated cradle 504 are also visible from the bottom view shown in FIG. 5G. The approximate location of the post 532 is also shown. As shown in FIG. 5G, post 532 is located approximately half way between the two parallel edges of the racetrack-shaped weighted base. This is shown through arrows 533A and 533B, which have approximately the same length. The approximate location of cradle mount 528 is also shown. In some embodiments, cradle mount 528 is located closer to one parallel edge of the racetrack-shaped weighted base than the other parallel edge. This is shown, for example, through arrow 529B, which is shorter than arrow 529A. In some embodiments, the cradle may be located elsewhere.

FIG. 5H shows an embodiment of the charging apparatus 500. Cross-sectional view 570 demonstrates a view of the apparatus along the cross-sectional dotted line 571. Certain internal features of or within base 502 (e.g., support members, circuitry wires, etc.) have been omitted. As shown in cross-sectional view 570, controller dock 506 is supported by post 532. Air-gap 507 is created between the top surface 525 of the base 502 and the bottom of controller dock 506. Cross-sectional view 572 demonstrates a view of the apparatus along the cross-sectional dotted line 573. As shown in cross-sectional view 572, controller dock 508 is supported by post 530. Air-gap 509 is created between the top surface 525 of the base 502 and the bottom of controller dock 508.

FIG. 5I shows an embodiment of the charging apparatus, with cross-sectional view 574 taken along the dotted line and in the direction of arrows 575. Certain internal features of or within base 502 (e.g., support members, circuitry wires, etc.) have been omitted. As shown in cross-sectional view 574, base 502 includes electronics 560. A pivot means 562, such as a spring, is also shown, which is configured to allow the elongated cradle 504 to pivot, such as when the weight of the artificial-reality headset is received (which pivoting movement may help to ensure mechanical stability of the charging apparatus 500, while also helping to ensure that electrical contact is maintained between a charging portion of the headset and a portion of the elongated cradle 504). In some embodiments, base 502 includes an open space 564 that is configured to provide space for the elongated cradle to pivot forwards and backwards. The depth 566 of the elongated cradle is also shown. Elongated cradle 504 is positioned above the top surface 525 of the base 502 such that an air gap 521 is created between the top surface 525 of base 502. As shown in FIG. 5I, at least two air gaps 521A, 521B may be created based on the dimensions and design of the elongated cradle 504.

FIGS. 5J, 5K-1, 5K-2, 5L-1, and 5L-2 show the charging apparatus 500 when the elongated cradle 504 is in a rested (or more upright) position and in a position where the elongated cradle 504 has pivoted downwards. FIG. 5J-1 shows a perspective view of the charging apparatus 500 where the elongated cradle 504 is in an upright or rested position and a portion of cradle mount 528 is visible. FIG. 5J-2 shows a view of the charging apparatus after the elongated cradle 504 has pivoted downward (or backward)—e.g., as would be the case when a headset is placed on the cradle-such that the cradle mount 528 has rotated backward and a larger portion of cradle mount 528 is visible from the front view.

FIGS. 5K-1 and 5K-2 show a cross sectional view of the charging apparatus in the center of the apparatus, for example similar to cross-sectional view 574 taken along the dotted line and in the direction of arrows 575 as shown in FIG. 5I. FIG. 5K-1 shows a view where the elongated cradle 504 is in an upright or rested position. Air gaps 521A and 521B are shown between a bottom portion on the front (721A) and back (721B) of the elongated cradle and the top surface 525 of base 502. The lip 523 of the protrusion of the elongated cradle 504 and open space 564 are also shown. FIG. 5K-2 shows a view of the charging apparatus after the elongated cradle 504 has pivoted downward (or backward). As a result, air gap 521A has increased and air gap 521B has decreased. Open space 564 of FIG. 5K-1 has been consumed by the portion of the elongated cradle (e.g., cradle mount 528) that has pivoted downwards into this open space.

FIGS. 5L-1 and 5L-2 show a back view of the charging apparatus before and after the elongated cradle 504 has pivoted. FIG. 5L-1 shows a view where the elongated cradle 504 is in an upright or rested position (e.g., when no headset is placed on the cradle). FIG. 5K-2 shows a view of the charging apparatus after the elongated cradle 504 has pivoted downward (or backward) (e.g., when a headset is placed on and resting on the cradle).

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 601, a head-wearable device, an HIPD 603, a smart textile-based garment 605, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

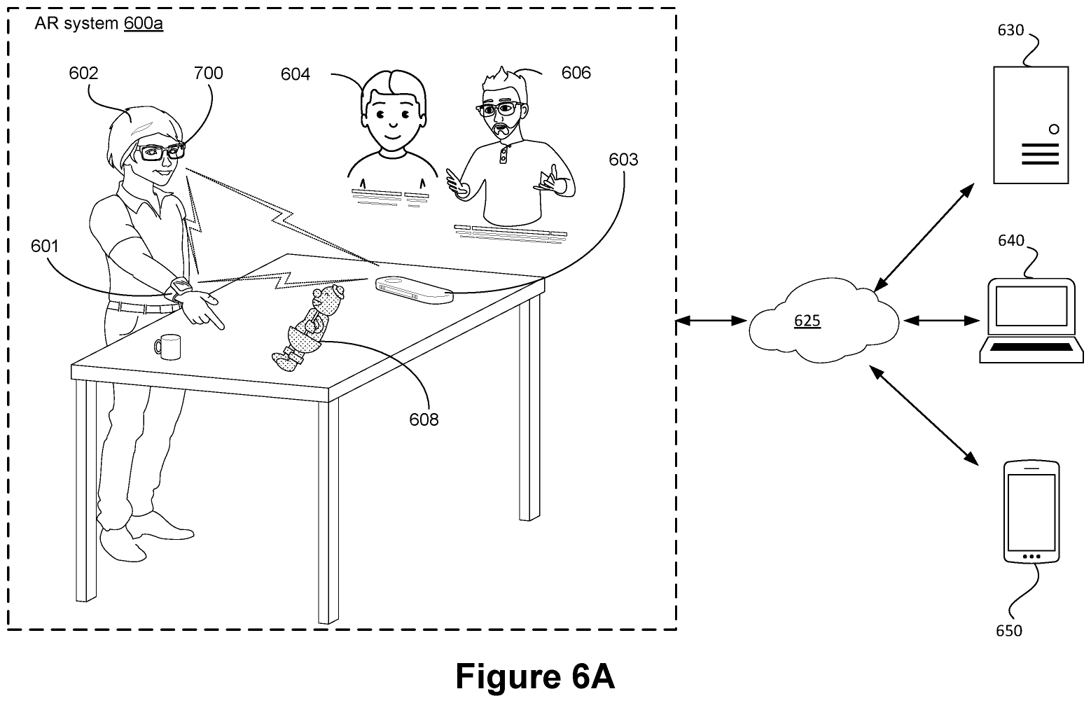

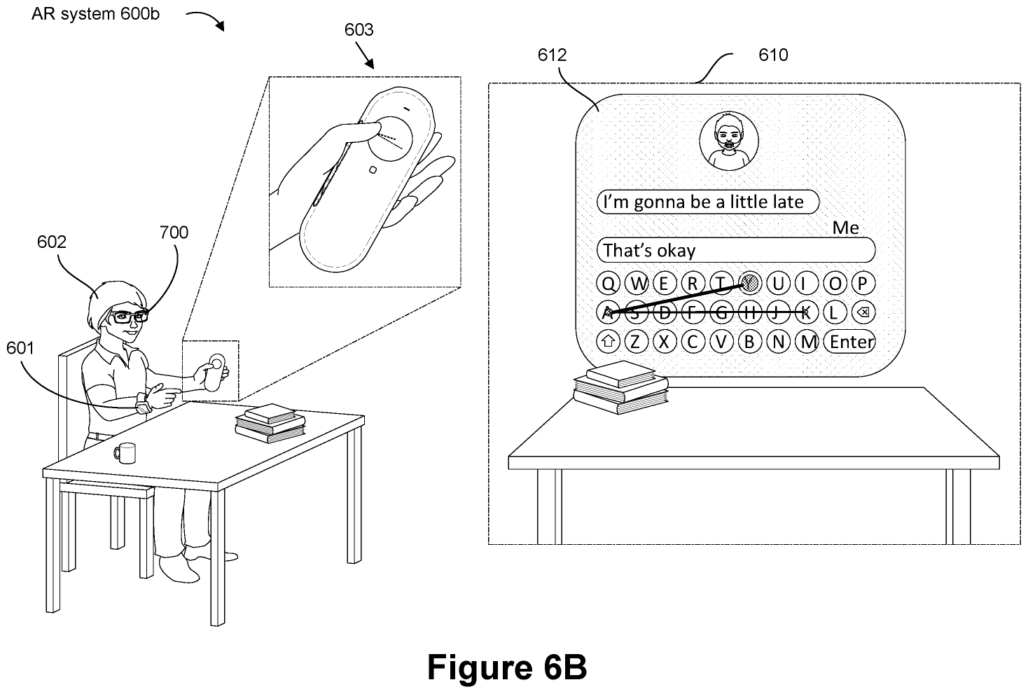

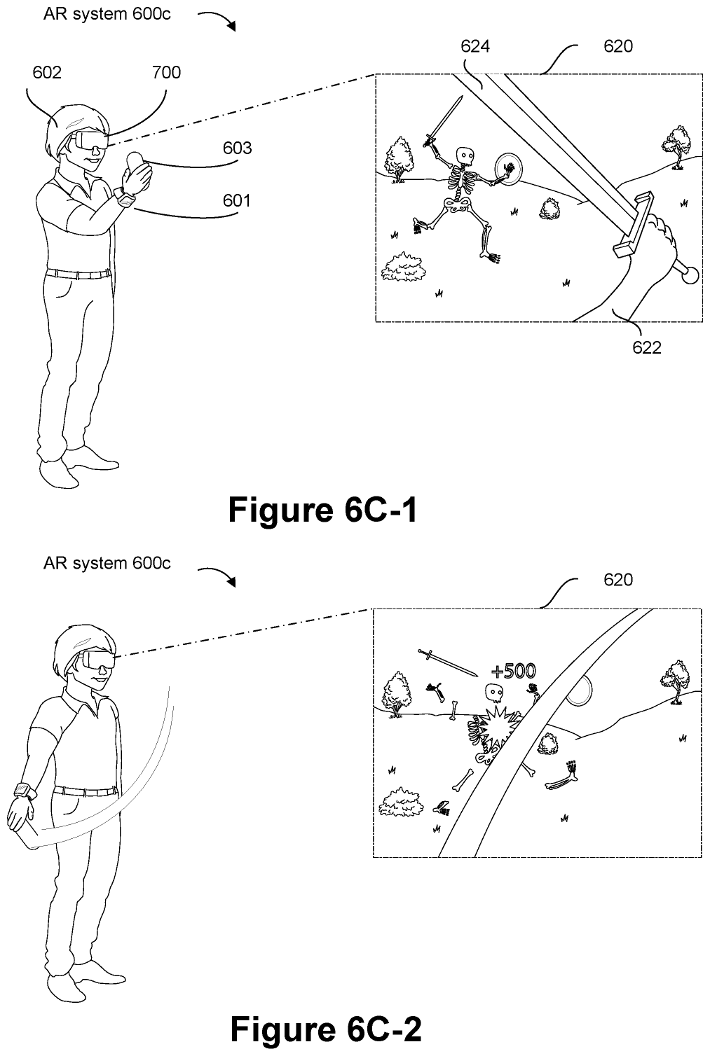

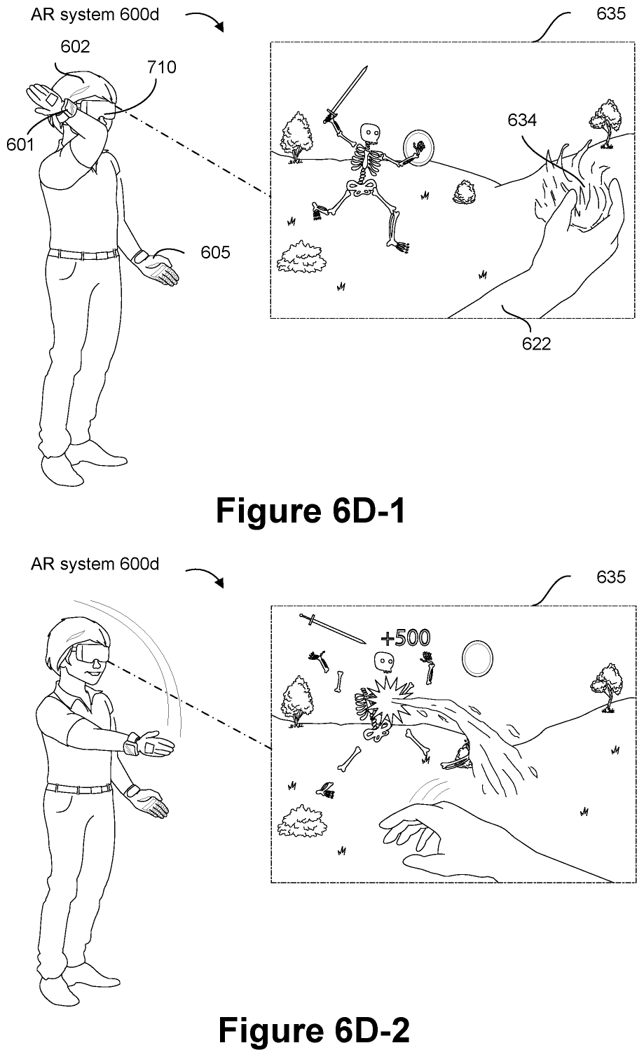

FIGS. 6A-6D-2 illustrate example artificial-reality systems, in accordance with some embodiments. FIG. 6A shows a first AR system 600a and first example user interactions using a wrist-wearable device 601, a head-wearable device (e.g., AR device 700), and/or a handheld intermediary processing device (HIPD) 603. FIG. 6B shows a second AR system 600b and second example user interactions using a wrist-wearable device 601, AR device 700, and/or an HIPD 603. FIGS. 6C-1 and 6C-2 show a third AR system 600c and third example user interactions using a wrist-wearable device 601, a head-wearable device (e.g., virtual-reality (VR) device 710), and/or an HIPD 603. FIGS. 6D-1 and 6D-2 show a fourth AR system 600d and fourth example user interactions using a wrist-wearable device 601, VR device 710, and/or a smart textile-based garment 605 (e.g., wearable gloves haptic gloves). As the skilled artisan will appreciate upon reading the descriptions provided herein, the above-example AR systems (described in detail below) can perform various functions and/or operations described above with reference to FIGS. 1A-5L-2.

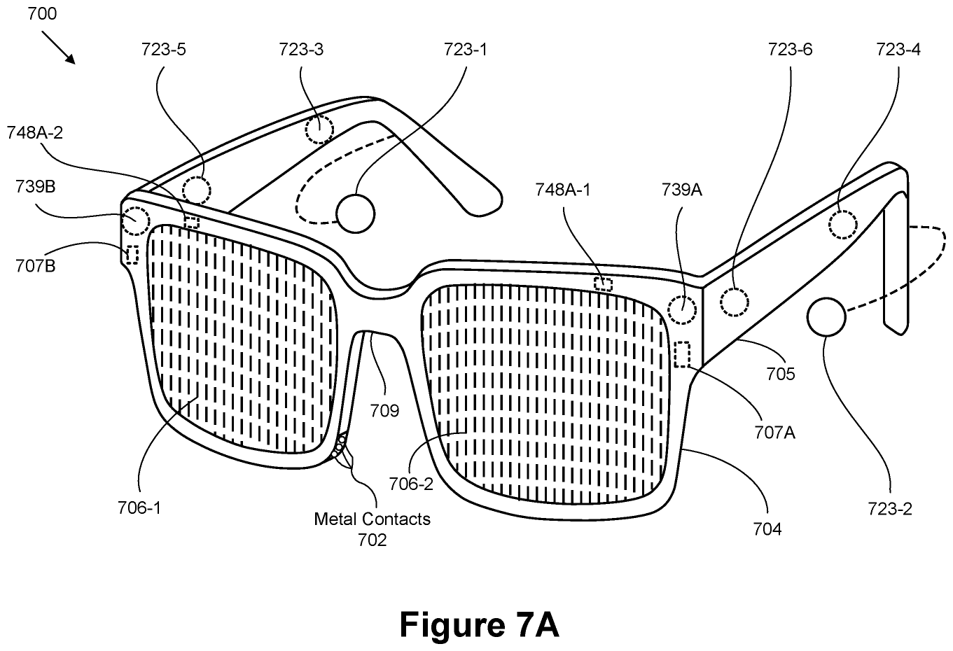

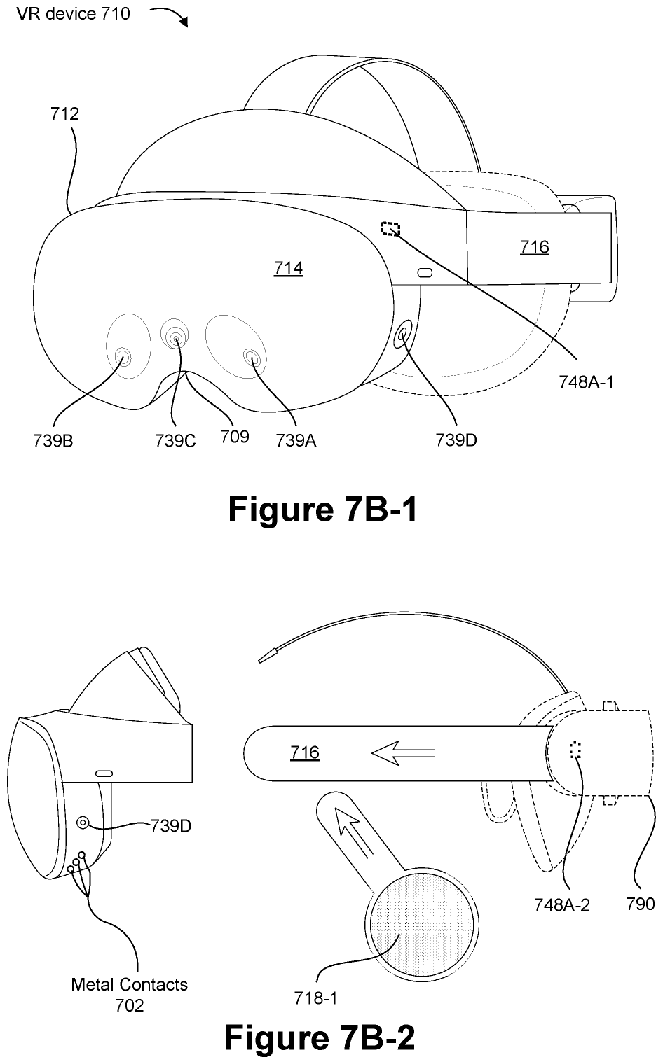

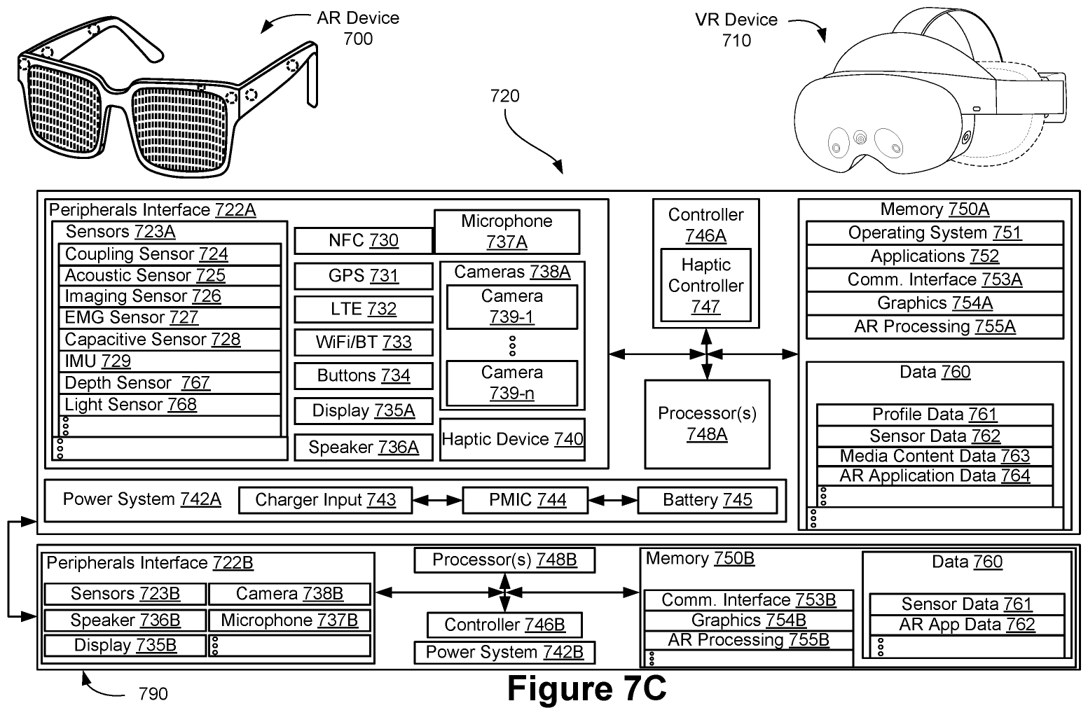

The head-wearable devices and their constituent components are described below in reference to FIGS. 7A-7D. The wrist-wearable device 601, the head-wearable devices, and/or the HIPD 603 can communicatively couple via a network 625 (e.g., cellular, near field, Wi-Fi, personal area network, wireless LAN, etc.). Additionally, the wrist-wearable device 601, the head-wearable devices, and/or the HIPD 603 can also communicatively couple with one or more servers 630, computers 640 (e.g., laptops, computers, etc.), mobile devices 650 (e.g., smartphones, tablets, etc.), and/or other electronic devices via the network 625 (e.g., cellular, near field, Wi-Fi, personal area network, wireless LAN, etc.). Similarly, the smart textile-based garment 605, when used, can also communicatively couple with the wrist-wearable device 601, the head-wearable devices, the HIPD 603, the one or more servers 630, the computers 640, the mobile devices 650, and/or other electronic devices via the network 625.

Turning to FIG. 6A, a user 602 is shown wearing the wrist-wearable device 601 and the AR device 700, and having the HIPD 603 on their desk. The wrist-wearable device 601, the AR device 700, and the HIPD 603 facilitate user interaction with an AR environment. In particular, as shown by the first AR system 600a, the wrist-wearable device 601, the AR device 700, and/or the HIPD 603 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 601, the AR device 700, and/or the HIPD 603.

The user 602 can use any of the wrist-wearable device 601, the AR device 700, and/or the HIPD 603 to provide user inputs. For example, the user 602 can perform one or more hand gestures that are detected by the wrist-wearable device 601 (e.g., using one or more EMG sensors and/or IMUs) and/or AR device 700 (e.g., using one or more image sensors or cameras, described below in reference to FIGS. 7A-7B) to provide a user input. Alternatively, or additionally, the user 602 can provide a user input via one or more touch surfaces of the wrist-wearable device 601, the AR device 700, and/or the HIPD 603, and/or voice commands captured by a microphone of the wrist-wearable device 601, the AR device 700, and/or the HIPD 603. In some embodiments, the wrist-wearable device 601, the AR device 700, and/or the HIPD 603 include a digital assistant to help the user in providing a user input (e.g., completing a sequence of operations, suggesting different operations or commands, providing reminders, confirming a command). In some embodiments, the user 602 can provide a user input via one or more facial gestures and/or facial expressions. For example, cameras of the wrist-wearable device 601, the AR device 700, and/or the HIPD 603 can track the user 602's eyes for navigating a user interface.

The wrist-wearable device 601, the AR device 700, and/or the HIPD 603 can operate alone or in conjunction to allow the user 602 to interact with the AR environment. In some embodiments, the HIPD 603 is configured to operate as a central hub or control center for the wrist-wearable device 601, the AR device 700, and/or another communicatively coupled device. For example, the user 602 can provide an input to interact with the AR environment at any of the wrist-wearable device 601, the AR device 700, and/or the HIPD 603, and the HIPD 603 can identify one or more back-end and front-end tasks to cause the performance of the requested interaction and distribute instructions to cause the performance of the one or more back-end and front-end tasks at the wrist-wearable device 601, the AR device 700, and/or the HIPD 603. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). The HIPD 603 can perform the back-end tasks and provide the wrist-wearable device 601 and/or the AR device 700 operational data corresponding to the performed back-end tasks such that the wrist-wearable device 601 and/or the AR device 700 can perform the front-end tasks. In this way, the HIPD 603, which has more computational resources and greater thermal headroom than the wrist-wearable device 601 and/or the AR device 700, performs computationally intensive tasks and reduces the computer resource utilization and/or power usage of the wrist-wearable device 601 and/or the AR device 700.

In the example shown by the first AR system 600a, the HIPD 603 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 603 performs back-end tasks for processing and/or rendering image data (and other data) associated with the AR video call and provides operational data associated with the performed back-end tasks to the AR device 700 such that the AR device 700 performs front-end tasks for presenting the AR video call (e.g., presenting the avatar 604 and the digital representation of the contact 606).

In some embodiments, the HIPD 603 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 603. In particular, the HIPD 603 and the AR device 700 operate in conjunction to determine a location for presenting the avatar 604 and the digital representation of the contact 606. In some embodiments, information can be presented within a predetermined distance from the HIPD 603 (e.g., within five meters). For example, as shown in the first AR system 600a, virtual object 608 is presented on the desk some distance from the HIPD 603. Similar to the above example, the HIPD 603 and the AR device 700 can operate in conjunction to determine a location for presenting the virtual object 608. Alternatively, in some embodiments, presentation of information is not bound by the HIPD 603. More specifically, the avatar 604, the digital representation of the contact 606, and the virtual object 608 do not have to be presented within a predetermined distance of the HIPD 603.

User inputs provided at the wrist-wearable device 601, the AR device 700, and/or the HIPD 603 are coordinated such that the user can use any device to initiate, continue, and/or complete an operation. For example, the user 602 can provide a user input to the AR device 700 to cause the AR device 700 to present the virtual object 608 and, while the virtual object 608 is presented by the AR device 700, the user 602 can provide one or more hand gestures via the wrist-wearable device 601 to interact and/or manipulate the virtual object 608.

FIG. 6B shows the user 602 wearing the wrist-wearable device 601 and the AR device 700, and holding the HIPD 603. In the second AR system 600b, the wrist-wearable device 601, the AR device 700, and/or the HIPD 603 are used to receive and/or provide one or more messages to a contact of the user 602. In particular, the wrist-wearable device 601, the AR device 700, and/or the HIPD 603 detect and coordinate one or more user inputs to initiate a messaging application and prepare a response to a received message via the messaging application.

In some embodiments, the user 602 initiates, via a user input, an application on the wrist-wearable device 601, the AR device 700, and/or the HIPD 603 that causes the application to initiate on at least one device. For example, in the second AR system 600b the user 602 performs a hand gesture associated with a command for initiating a messaging application (represented by messaging user interface 612); the wrist-wearable device 601 detects the hand gesture; and, based on a determination that the user 602 is wearing AR device 700, causes the AR device 700 to present a messaging user interface 612 of the messaging application. The AR device 700 can present the messaging user interface 612 to the user 602 via its display (e.g., as shown by user 602's field of view 610). In some embodiments, the application is initiated and can be run on the device (e.g., the wrist-wearable device 601, the AR device 700, and/or the HIPD 603) that detects the user input to initiate the application, and the device provides another device operational data to cause the presentation of the messaging application. For example, the wrist-wearable device 601 can detect the user input to initiate a messaging application, initiate and run the messaging application, and provide operational data to the AR device 700 and/or the HIPD 603 to cause presentation of the messaging application. Alternatively, the application can be initiated and run at a device other than the device that detected the user input. For example, the wrist-wearable device 601 can detect the hand gesture associated with initiating the messaging application and cause the HIPD 603 to run the messaging application and coordinate the presentation of the messaging application.

Further, the user 602 can provide a user input provided at the wrist-wearable device 601, the AR device 700, and/or the HIPD 603 to continue and/or complete an operation initiated at another device. For example, after initiating the messaging application via the wrist-wearable device 601 and while the AR device 700 presents the messaging user interface 612, the user 602 can provide an input at the HIPD 603 to prepare a response (e.g., shown by the swipe gesture performed on the HIPD 603). The user 602's gestures performed on the HIPD 603 can be provided and/or displayed on another device. For example, the user 602's swipe gestures performed on the HIPD 603 are displayed on a virtual keyboard of the messaging user interface 612 displayed by the AR device 700.

In some embodiments, the wrist-wearable device 601, the AR device 700, the HIPD 603, and/or other communicatively coupled devices can present one or more notifications to the user 602. The notification can be an indication of a new message, an incoming call, an application update, a status update, etc. The user 602 can select the notification via the wrist-wearable device 601, the AR device 700, or the HIPD 603 and cause presentation of an application or operation associated with the notification on at least one device. For example, the user 602 can receive a notification that a message was received at the wrist-wearable device 601, the AR device 700, the HIPD 603, and/or other communicatively coupled device and provide a user input at the wrist-wearable device 601, the AR device 700, and/or the HIPD 603 to review the notification, and the device detecting the user input can cause an application associated with the notification to be initiated and/or presented at the wrist-wearable device 601, the AR device 700, and/or the HIPD 603.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 700 can present to the user 602 game application data and the HIPD 603 can use a controller to provide inputs to the game. Similarly, the user 602 can use the wrist-wearable device 601 to initiate a camera of the AR device 700, and the user can use the wrist-wearable device 601, the AR device 700, and/or the HIPD 603 to manipulate the image capture (e.g., zoom in or out, apply filters, etc.) and capture image data.

Turning to FIGS. 6C-1 and 6C-2, the user 602 is shown wearing the wrist-wearable device 601 and a VR device 710, and holding the HIPD 603. In the third AR system 600c, the wrist-wearable device 601, the VR device 710, and/or the HIPD 603 are used to interact within an AR environment, such as a VR game or other AR application. While the VR device 710 present a representation of a VR game (e.g., first AR game environment 620) to the user 602, the wrist-wearable device 601, the VR device 710, and/or the HIPD 603 detect and coordinate one or more user inputs to allow the user 602 to interact with the VR game.

In some embodiments, the user 602 can provide a user input via the wrist-wearable device 601, the VR device 710, and/or the HIPD 603 that causes an action in a corresponding AR environment. For example, the user 602 in the third AR system 600c (shown in FIG. 6C-1) raises the HIPD 603 to prepare for a swing in the first AR game environment 620. The VR device 710, responsive to the user 602 raising the HIPD 603, causes the AR representation of the user 622 to perform a similar action (e.g., raise a virtual object, such as a virtual sword 624). In some embodiments, each device uses respective sensor data and/or image data to detect the user input and provide an accurate representation of the user 602's motion. For example, image sensors (e.g., SLAM cameras or other cameras) of the HIPD 603 can be used to detect a position of the 603 relative to the user 602's body such that the virtual object can be positioned appropriately within the first AR game environment 620; sensor data from the wrist-wearable device 601 can be used to detect a velocity at which the user 602 raises the HIPD 603 such that the AR representation of the user 622 and the virtual sword 624 are synchronized with the user 602's movements; and image sensors 726 (FIGS. 7A-7C) of the VR device 710 can be used to represent the user 602's body, boundary conditions, or real-world objects within the first AR game environment 620.

In FIG. 6C-2, the user 602 performs a downward swing while holding the HIPD 603. The user 602's downward swing is detected by the wrist-wearable device 601, the VR device 710, and/or the HIPD 603 and a corresponding action is performed in the first AR game environment 620. In some embodiments, the data captured by each device is used to improve the user's experience within the AR environment. For example, sensor data of the wrist-wearable device 601 can be used to determine a speed and/or force at which the downward swing is performed and image sensors of the HIPD 603 and/or the VR device 710 can be used to determine a location of the swing and how it should be represented in the first AR game environment 620, which, in turn, can be used as inputs for the AR environment (e.g., game mechanics, which can use detected speed, force, locations, and/or aspects of the user 602's actions to classify a user's inputs (e.g., user performs a light strike, hard strike, critical strike, glancing strike, miss) or calculate an output (e.g., amount of damage)).

While the wrist-wearable device 601, the VR device 710, and/or the HIPD 603 are described as detecting user inputs, in some embodiments, user inputs are detected at a single device (with the single device being responsible for distributing signals to the other devices for performing the user input). For example, the HIPD 603 can operate an application for generating the first AR game environment 620 and provide the VR device 710 with corresponding data for causing the presentation of the first AR game environment 620, as well as detect the 602's movements (while holding the HIPD 603) to cause the performance of corresponding actions within the first AR game environment 620. Additionally or alternatively, in some embodiments, operational data (e.g., sensor data, image data, application data, device data, and/or other data) of one or more devices is provide to a single device (e.g., the HIPD 603) to process the operational data and cause respective devices to perform an action associated with processed operational data.

FIGS. 6D-1 and 6D-2, the user 602 is shown wearing the wrist-wearable device 601, the VR device 710, smart textile-based garments 605. In the fourth AR system 600d, the wrist-wearable device 601, the VR device 710, and/or the smart textile-based garments 605 are used to interact within an AR environment (e.g., any AR system described above in reference to FIGS. 6A-6C-2. While the VR device 710 present a representation of a VR game (e.g., second AR game environment 630) to the user 602, the wrist-wearable device 601, the VR device 710, and/or the smart textile-based garments 605 detect and coordinate one or more user inputs to allow the user 602 to interact with the AR environment.

In some embodiments, the user 602 can provide a user input via the wrist-wearable device 601, the VR device 710, and/or the smart textile-based garments 605 that causes an action in a corresponding AR environment. For example, the user 602 in the fourth AR system 600d (shown in FIG. 6D-1) raises a hand wearing the smart textile-based garments 605 to prepare for cast spell or throw an object within the second AR game environment 630. The VR device 710, responsive to the user 602 holding up their hand (wearing a smart textile-based garments 605), causes the AR representation of the user 622 to perform a similar action (e.g., hold a virtual object, such as a casting a fireball 634). In some embodiments, each device uses respective sensor data and/or image data to detect the user input and provide an accurate representation of the user 602's motion.

In FIG. 6D-2, the user 602 performs a throwing motion while wearing the smart textile-based garment 605. The user 602's throwing motion is detected by the wrist-wearable device 601, the VR device 710, and/or the smart textile-based garments 605 and a corresponding action is performed in the second AR game environment 630. As described above, the data captured by each device is used to improve the user's experience within the AR environment. Although not shown, the smart textile-based garments 605 can be used in conjunction with an AR device 710 and/or an HIPD 603.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Head-Wearable Devices

FIGS. 7A-7C show example head-wearable devices, in accordance with some embodiments. Head-wearable devices can include, but are not limited to, AR devices 710 (e.g., AR or smart eyewear devices, such as smart glasses, smart monocles, smart contacts, etc.), VR devices 710 (e.g., VR headsets, head-mounted displays (HMD)s, etc.), or other occularly coupled devices. The AR devices 700 and the VR devices 710 are instances of the head-wearable devices described in reference to FIGS. 1A-5L-2 herein, such that the head-wearable device should be understood to have the features of the AR devices 700 and/or the VR devices 710, and vice versa. The AR devices 700 and the VR devices 710 can perform various functions and/or operations associated with navigating through user interfaces and selectively opening applications, as well as the functions and/or operations described above with reference to FIGS. 1A-5L-2.

In some embodiments, an AR system (e.g., AR systems 600a-600d; FIGS. 6A-6D-2) includes an AR device 700 (as shown in FIG. 7A) and/or VR device 710 (as shown in FIGS. 7B-1-B-2). In some embodiments, the AR device 700 and the VR device 710 can include one or more analogous components (e.g., components for presenting interactive artificial-reality environments, such as processors, memory, and/or presentation devices, including one or more displays and/or one or more waveguides), some of which are described in more detail with respect to FIG. 7C. The head-wearable devices can use display projectors (e.g., display projector assemblies 707A and 707B) and/or waveguides for projecting representations of data to a user. Some embodiments of head-wearable devices do not include displays.

FIG. 7A shows an example visual depiction of the AR device 700 (e.g., which may also be described herein as augmented-reality glasses and/or smart glasses). The AR device 700 can work in conjunction with additional electronic components that are not shown in FIGS. 7A, such as a wearable accessory device and/or an intermediary processing device, in electronic communication or otherwise configured to be used in conjunction with the AR device 700. In some embodiments, the wearable accessory device and/or the intermediary processing device may be configured to couple with the AR device 700 via a coupling mechanism in electronic communication with a coupling sensor 724, where the coupling sensor 724 can detect when an electronic device becomes physically or electronically coupled with the AR device 700. In some embodiments, the AR device 700 can be configured to couple to a housing (e.g., a portion of frame 704 or temple arms 705), which may include one or more additional coupling mechanisms configured to couple with additional accessory devices. The components shown in FIG. 7A can be implemented in hardware, software, firmware, or a combination thereof, including one or more signal-processing components and/or application-specific integrated circuits (ASICs).

The AR device 700 includes mechanical glasses components, including a frame 704 configured to hold one or more lenses (e.g., one or both lenses 706-1 and 706-2). One of ordinary skill in the art will appreciate that the AR device 700 can include additional mechanical components, such as hinges configured to allow portions of the frame 704 of the AR device 700 to be folded and unfolded, a bridge configured to span the gap between the lenses 706-1 and 706-2 and rest on the user's nose, nose pads configured to rest on the bridge of the nose and provide support for the AR device 700, earpieces configured to rest on the user's ears and provide additional support for the AR device 700, temple arms 705 configured to extend from the hinges to the earpieces of the AR device 700, and the like. One of ordinary skill in the art will further appreciate that some examples of the AR device 700 can include none of the mechanical components described herein. For example, smart contact lenses configured to present artificial-reality to users may not include any components of the AR device 700.

The lenses 706-1 and 706-2 can be individual displays or display devices (e.g., a waveguide for projected representations). The lenses 706-1 and 706-2 may act together or independently to present an image or series of images to a user. In some embodiments, the lenses 706-1 and 706-2 can operate in conjunction with one or more display projector assemblies 707A and 707B to present image data to a user. While the AR device 700 includes two displays, embodiments of this disclosure may be implemented in AR devices with a single near-eye display (NED) or more than two NEDs.

The AR device 700 includes electronic components, many of which will be described in more detail below with respect to FIG. 7C. Some example electronic components are illustrated in FIG. 7A, including sensors 723-1, 723-2, 723-3, 723-4, 723-5, and 723-6, which can be distributed along a substantial portion of the frame 704 of the AR device 700. The different types of sensors are described below in reference to FIG. 7C. The AR device 700 also includes a left camera 739A and a right camera 739B, which are located on different sides of the frame 704. And the eyewear device includes one or more processors 748A and 748B (e.g., an integral microprocessor, such as an ASIC) that is embedded into a portion of the frame 704.

FIGS. 7B-1 and 7B-2 show an example visual depiction of the VR device 710 (e.g., a head-mounted display (HMD) 712, also referred to herein as an artificial-reality headset, a head-wearable device, a VR headset, etc.). The HMD 712 includes a front body 714 and a frame 716 (e.g., a strap or band) shaped to fit around a user's head. In some embodiments, the front body 714 and/or the frame 716 includes one or more electronic elements for facilitating presentation of and/or interactions with an AR and/or VR system (e.g., displays, processors (e.g., processor 748A-1), IMUs, tracking emitter or detectors, sensors, etc.). In some embodiments, the HMD 712 includes output audio transducers (e.g., an audio transducer 718-1), as shown in FIG. 7B-2. In some embodiments, one or more components, such as the output audio transducer(s) 718-1 and the frame 716, can be configured to attach and detach (e.g., are detachably attachable) to the HMD 712 (e.g., a portion or all of the frame 716, and/or the output audio transducer 718-1), as shown in FIG. 7B-2. In some embodiments, coupling a detachable component to the HMD 712 causes the detachable component to come into electronic communication with the HMD 712. The VR device 710 includes electronic components, many of which will be described in more detail below with respect to FIG. 7C.

FIG. 7B-1 to 7B-2 also show that the VR device 710 one or more cameras, such as the left camera 739A and the right camera 739B, which can be analogous to the left and right cameras on the frame 704 of the AR device 700. In some embodiments, the VR device 710 includes one or more additional cameras (e.g., cameras 739C and 739D), which can be configured to augment image data obtained by the cameras 739A and 739B by providing more information. For example, the camera 739C can be used to supply color information that is not discerned by cameras 739A and 739B. In some embodiments, one or more of the cameras 739A to 739D can include an optional IR cut filter configured to remove IR light from being received at the respective camera sensors.

The VR device 710 can include a housing 790 storing one or more components of the VR device 710 and/or additional components of the VR device 710. The housing 790 can be a modular electronic device configured to couple with the VR device 710 (or an AR device 700) and supplement and/or extend the capabilities of the VR device 710 (or an AR device 700). For example, the housing 790 can include additional sensors, cameras, power sources, processors (e.g., processor 748A-2), etc. to improve and/or increase the functionality of the VR device 710. Examples of the different components included in the housing 790 are described below in reference to FIG. 7C.

Alternatively or in addition, in some embodiments, the head-wearable device, such as the VR device 710 and/or the AR device 700), includes, or is communicatively coupled to, another external device (e.g., a paired device), such as an HIPD 603 and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 603, an optional neckband, and/or wearable accessory device) with the head-wearable devices (e.g., an AR device 700 and/or VR device 710) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 603) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 603, can process information generated by one or more sensors of its sensors and/or information provided by other communicatively coupled devices. For example, a head-wearable device can include an IMU, and the intermediary processing device (neckband and/or an HIPD 603) can compute all inertial and spatial calculations from the IMUs located on the head-wearable device.

Artificial-reality systems may include a variety of types of visual feedback mechanisms. For example, display devices in the AR devices 700 and/or the VR devices 710 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 700 and/or the VR device 710 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 700 and the VR device 710, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

The AR device 700 and/or the VR device 710 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 601, an HIPD 603, smart textile-based garment 605, etc.), and/or other devices described herein.

In some embodiments, the AR device 700 and/or the VR device 710 include metal contacts 702. Metal contacts 702 are provided, for example, on a bottom portion of the headset. In FIGS. 7A-7B-2, the headset includes three metal contacts. These metal contacts are configured to align with the corresponding metal contacts on the elongated cradle when a portion of the headset is received by the elongated cradle of the charging apparatus 100. In the embodiment shown in FIGS. 7B-1 and 7B-2, three metal contacts are provided, which is the same number of metal contacts as provided in the charging apparatus shown in, for example, FIGS. 1A-1I. In some embodiments, the number of metal contacts 702 is the same or different from the number of metal contacts 105 on the elongated cradle 104 of the charging apparatus 100. In some embodiments, a first metal contact is for communicating data (e.g., a data line for communicating a charging status, charging characteristics (e.g., voltage, etc.), etc.), a second metal contact is a positive contact or terminal, and a third metal contact is a negative contact or terminal. In some embodiments, a ground terminal may also be included. The ground terminal may replace one of the three aforementioned contacts or may be added as a fourth metal contact. These terminals may be used in other configurations as well. The AR device 700 and/or the VR device 710 may also include a nose indent 709, which is configured to align with protrusion 120 of the elongated cradle to help secure and align the headset with the elongated cradle and metal contacts of the headset and the elongated cradle.

FIG. 7C illustrates a computing system 720 and an optional housing 790, each of which show components that can be included in a head-wearable device (e.g., the AR device 700 and/or the VR device 710). In some embodiments, more or less components can be included in the optional housing 790 depending on practical restraints of the respective head-wearable device being described. Additionally or alternatively, the optional housing 790 can include additional components to expand and/or augment the functionality of a head-wearable device.

In some embodiments, the computing system 720 and/or the optional housing 790 can include one or more peripheral interfaces 722A and 722B, one or more power systems 742A and 742B (including charger input 743, PMIC 744, and battery 745), one or more controllers 746A 746B (including one or more haptic controllers 747), one or more processors 748A and 748B (as defined above, including any of the examples provided), and memory 750A and 750B, which can all be in electronic communication with each other. For example, the one or more processors 748A and/or 748B can be configured to execute instructions stored in the memory 750A and/or 750B, which can cause a controller of the one or more controllers 746A and/or 746B to cause operations to be performed at one or more peripheral devices of the peripherals interfaces 722A and/or 722B. In some embodiments, each operation described can occur based on electrical power provided by the power system 742A and/or 742B.

In some embodiments, the peripherals interface 722A can include one or more devices configured to be part of the computing system 720, many of which have been defined above. For example, the peripherals interface can include one or more sensors 723A. Some example sensors include: one or more coupling sensors 724, one or more acoustic sensors 725, one or more imaging sensors 726, one or more EMG sensors 727, one or more capacitive sensors 728, and/or one or more IMUs 729. In some embodiments, the sensors 723A further include depth sensors 767, light sensors 768 and/or any other types of sensors defined above or described with respect to any other embodiments discussed herein.

In some embodiments, the peripherals interface can include one or more additional peripheral devices, including one or more NFC devices 730, one or more GPS devices 731, one or more LTE devices 732, one or more WiFi and/or Bluetooth devices 733, one or more buttons 734 (e.g., including buttons that are slidable or otherwise adjustable), one or more displays 735A, one or more speakers 736A, one or more microphones 737A, one or more cameras 738A (e.g., including the a first camera 739-1 through nth camera 739-n, which are analogous to the left camera 739A and/or the right camera 739B), one or more haptic devices 740; and/or any other types of peripheral devices defined above or described with respect to any other embodiments discussed herein.

The head-wearable devices can include a variety of types of visual feedback mechanisms (e.g., presentation devices). For example, display devices in the AR device 700 and/or the VR device 710 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 735A can be coupled to each of the lenses 706-1 and 706-2 of the AR device 700. The displays 735A coupled to each of the lenses 706-1 and 706-2 can act together or independently to present an image or series of images to a user. In some embodiments, the AR device 700 and/or the VR device 710 includes a single display 735A (e.g., a near-eye display) or more than two displays 735A.

In some embodiments, a first set of one or more displays 735A can be used to present an augmented-reality environment, and a second set of one or more display devices 735A can be used to present a virtual-reality environment. In some embodiments, one or more waveguides are used in conjunction with presenting artificial-reality content to the user of the AR device 700 and/or the VR device 710 (e.g., as a means of delivering light from a display projector assembly and/or one or more displays 735A to the user's eyes). In some embodiments, one or more waveguides are fully or partially integrated into the AR device 700 and/or the VR device 710. Additionally, or alternatively to display screens, some artificial-reality systems include one or more projection systems. For example, display devices in the AR device 700 and/or the VR device 710 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 735A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 735A for presenting information to users. For example, an external display 735A can be used to show a current battery level, network activity (e.g., connected, disconnected, etc.), current activity (e.g., playing a game, in a call, in a meeting, watching a movie, etc.), and/or other relevant information. In some embodiments, the external displays 735A can be used to communicate with others. For example, a user of the head-wearable device can cause the external displays 735A to present a do not disturb notification. The external displays 735A can also be used by the user to share any information captured by the one or more components of the peripherals interface 722A and/or generated by head-wearable device (e.g., during operation and/or performance of one or more applications).

The memory 750A can include instructions and/or data executable by one or more processors 748A (and/or processors 748B of the housing 790) and/or a memory controller of the one or more controllers 746A (and/or controller 746B of the housing 790). The memory 750A can include one or more operating systems 751; one or more applications 752; one or more communication interface modules 753A; one or more graphics modules 754A; one or more AR processing modules 755A; and/or any other types of modules or components defined above or described with respect to any other embodiments discussed herein.

The data 760 stored in memory 750A can be used in conjunction with one or more of the applications and/or programs discussed above. The data 760 can include profile data 761; sensor data 762; media content data 763; AR application data 764; and/or any other types of data defined above or described with respect to any other embodiments discussed herein.

In some embodiments, the controller 746A of the head-wearable devices processes information generated by the sensors 723A on the head-wearable devices and/or another component of the head-wearable devices and/or communicatively coupled with the head-wearable devices (e.g., components of the housing 790, such as components of peripherals interface 722B). For example, the controller 746A can process information from the acoustic sensors 725 and/or image sensors 726. For each detected sound, the controller 746A can perform a direction of arrival (DOA) estimation to estimate a direction from which the detected sound arrived at a head-wearable device. As one or more of the acoustic sensors 725 detects sounds, the controller 746A can populate an audio data set with the information (e.g., represented by sensor data 762).

In some embodiments, a physical electronic connector can convey information between the head-wearable devices and another electronic device, and/or between one or more processors 748A of the head-wearable devices and the controller 746A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 603) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 700 and/or the VR device 710 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 7B-1 and 7B-2 show the VR device 710 having cameras 739A-739D, which can be used to provide depth information for creating a voxel field and a two-dimensional mesh to provide object information to the user to avoid collisions.

The optional housing 790 can include analogous components to those describe above with respect to the computing system 720. For example, the optional housing 790 can include a respective peripherals interface 722B including more or less components to those described above with respect to the peripherals interface 722A. As described above, the components of the optional housing 790 can be used augment and/or expand on the functionality of the head-wearable devices. For example, the optional housing 790 can include respective sensors 723B, speakers 736B, displays 735B, microphones 737B, cameras 738B, and/or other components to capture and/or present data. Similarly, the optional housing 790 can include one or more processors 748B, controllers 746B, and/or memory 750B (including respective communication interface modules 753B; one or more graphics modules 754B; one or more AR processing modules 755B, etc.) that can be used individually and/or in conjunction with the components of the computing system 720.

The techniques described above in FIGS. 7A-7C can be used with different head-wearable devices. In some embodiments, the head-wearable devices (e.g., the AR device 700 and/or the VR device 710) can be used in conjunction with one or more wearable device such as a wrist-wearable device 601 (or components thereof) and/or a smart textile-based garment 605, as well as an HIPD 603.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A charging apparatus, comprising:
a racetrack-shaped weighted base, including a top surface and a bottom surface, wherein the top surface and the bottom surface of the racetrack-shaped weighted base are both substantially flat;
an elongated cradle mounted to the racetrack-shaped weighted base, the elongated cradle:
positioned above the top surface of the racetrack-shaped weighted base such that an air gap is created between part of a bottom surface of the elongated cradle and the top surface of the racetrack-shaped weighted base,
including one or more metal contacts configured for charging a headset, and
configured to align the one or more metal contacts with corresponding metal contacts on a portion of the headset that is received by the elongated cradle;
a first controller dock mounted to the racetrack-shaped weighted base, the first controller dock:
positioned above the top surface of the racetrack-shaped weighted base such that an air gap is created between part of a bottom surface of the first controller dock and the top surface of the racetrack-shaped weighted base, and
configured for receiving and wirelessly charging a first controller; and
a second controller dock mounted to the racetrack-shaped weighted base, the second controller dock:
positioned above the top surface of the racetrack-shaped weighted base such that an air gap is created between part of a bottom portion of the second controller dock and the top surface of the racetrack-shaped weighted base, and
configured for receiving and wirelessly charging a second controller.

2. The charging apparatus of claim 1, wherein:
the elongated cradle is further configured to be pivotable at a point where the elongated cradle is mounted to the racetrack-shaped weighted base such that the one or more metal contacts are aligned with corresponding metal contacts on the portion of the headset that is received by the elongated cradle.

3. The charging apparatus of claim 2, further comprising:
a spring in communication with the elongated cradle;
wherein the spring is configured to allow the elongated cradle to pivot between at least a first position and a second position; and
wherein the spring has a spring force of between 200-450 g.

4. The charging apparatus of claim 1, wherein:
the one or more metal contacts configured for charging the headset are pogo pins.

5. The charging apparatus of claim 1, wherein:
the one or more metal contacts include at least three metal contacts, wherein a first metal contact of the at least three metal contracts is configured for communicating data, a second metal contact of the at least three metal contracts is configured to be a positive contact, and a third metal contact of the at least three metal contracts is configured to be a negative contact.

6. The charging apparatus of claim 1, wherein:
a depth of the elongated cradle is between 15-35 millimeters.

7. The charging apparatus of claim 1, wherein:
the elongated cradle is configured to charge the headset without using a magnetic-coupling structure.

8. The charging apparatus of claim 1, wherein:
the elongated cradle is mounted to the racetrack-shaped weighted base at a position that is closer to a first parallel edge of the racetrack-shaped weighted base than a second parallel edge of the racetrack-shaped weighted base that is opposite to the first parallel edge.

9. The charging apparatus of claim 1, wherein:
the headset further includes a headset-strap, and
the elongated cradle is further configured to charge the headset while it is coupled with the headset-strap when at least a portion of the headset-strap of the headset rests on a separate surface.

10. The charging apparatus of claim 1, wherein:
the racetrack-shaped weighted base is no more than 15 millimeters thick.

11. The charging apparatus of claim 1, wherein:
the racetrack-shaped weighted base further includes a plurality of lights, wherein the plurality of lights includes:
a first light operatively associated with the elongated cradle, positioned next to the elongated cradle along the racetrack-shaped weighted base, and configured for indicating a headset-charge status of the headset,
a second light operatively associated with the first controller dock, positioned next to the first controller dock along the racetrack-shaped weighted base, and configured for indicating a first controller-charge status of the first controller,
a third light operatively associated with the second controller dock, positioned next to the second controller dock along the racetrack-shaped weighted base, and configured for indicating a second-controller charge status of the second controller.

12. The charging apparatus of claim 1, wherein:
the racetrack-shaped weighted base further includes an added weight in addition to the weight of a housing of the racetrack-shaped weighted base;
wherein the added weight is at least 300 grams.

13. The charging apparatus of claim 1, wherein:
the first controller dock is mounted on a first side of the elongated cradle; and
the second controller dock is mounted on a second side of the elongated cradle;
wherein the second side of the elongated cradle is substantially opposite the first side of the elongated cradle.

14. The charging apparatus of claim 1, wherein:
the first controller dock is mounted to the racetrack-shaped weighted base at a location that is substantially half-way between a first parallel edge of the racetrack-shaped weighted base and a second parallel edge of the racetrack-shaped weighted base;
the second controller dock is mounted to the racetrack-shaped weighted base at a location that is substantially half-way between the first parallel edge of the racetrack-shaped weighted base and the second parallel edge of the racetrack-shaped weighted base;
wherein the first parallel edge of the racetrack-shaped weighted base is opposite to the second parallel edge of the racetrack-shaped weighted base.

15. The charging apparatus of claim 1, wherein:
the first controller dock further includes slip-resistant material configured to position the first controller; and
the second controller dock further includes slip-resistant material configured to position the second controller.

16. The charging apparatus of claim 1, wherein:
the first controller dock is further configured to position the first controller through a gravity-hold mechanism; and
the second controller dock is further configured to hold the second controller through a gravity-hold mechanism.

17. The charging apparatus of claim 1, wherein:
the first controller dock further includes a non-stick material configured to position the first controller; and
the second controller dock further includes a non-stick material configured to position the second controller.

18. The charging apparatus of claim 1, wherein:
the elongated cradle further includes at least one protrusion that is configured to align with an indent of the headset and a lip that is configured to interact with a recess on the indent of the headset.

19. A charging device comprising:
a racetrack-shaped weighted base, including a top surface and a bottom surface, wherein the top surface and the bottom surface of the racetrack-shaped weighted base are both substantially flat;
a headset-charging means mounted to the racetrack-shaped weighted base, wherein the headset-charging means:
is positioned entirely above the top surface of the racetrack-shaped weighted base such that an air gap is created between part of a bottom surface of the headset-charging means and the top surface of the racetrack-shaped weighted base,
includes a first charging means configured for charging a headset, and
is configured to align the first charging means with corresponding second charging means on a portion of the headset that is received by the headset-charging means;
a first controller-charging means mounted to the racetrack-shaped weighted base, wherein the first controller-charging means:
is positioned entirely above the top surface of the racetrack-shaped weighted base such that an air gap is created between part of a bottom surface of the first controller-charging means and the top surface of the racetrack-shaped weighted base, and
is configured for receiving and wirelessly charging a first controller; and
a second controller-charging means mounted to the racetrack-shaped weighted base, wherein the second controller-charging means:
is positioned entirely above the top surface of the racetrack-shaped weighted base such that an air gap is created between part of a bottom portion of the second controller-charging means and the top surface of the racetrack-shaped weighted base, and
is configured for receiving and wirelessly charging a second controller.

20. The charging device of claim 19, wherein:
the racetrack-shaped weighted base further includes an added weight in addition to the weight of a housing of the racetrack-shaped weighted base;
wherein the added weight is at least 300 grams.
